(19) United States
(12) Patent Application Publication
(10) Pub. No.: US 2016/0202088 A1
(43) Pub. Date: Jul. 14, 2016

(54) ANGULAR POSITION DETECTION DEVICE

(71) Applicant: PANASONIC INTELLECTUAL PROPERTY MANAGEMENT CO., LTD., Osaka (JP)

(72) Inventor: KENICHI KISHIMOTO, Osaka (JP)

(21) Appl. No.: 14/913,376

(22) PCT Filed: Aug. 27, 2014
(86) PCT No.: PCT/JP2014/004388

§ 371 Date: Feb. 22, 2016

(30) Foreign Application Priority Data
Aug. 30, 2013 (JP) 2013-179036

(51) Int. Cl. G01D 5/245

(52) U.S. Cl. CPC G01D 5/2451

(57) ABSTRACT

Angle position detection device (102) of the present invention includes resolver (101), sampling instruction signal generator (107), first analog-digital converter (103), second analog-digital converter (104), and resolver digital converter (105). Resolver (101) outputs an A-phase signal and a B-phase signal having a phase difference of 90 degrees relative to the A-phase signal. When first analog-digital converter (103) and second analog-digital converter (104) receives a sampling instruction signal, first analog-digital converter (103) and second analog-digital converter (104) convert the A-phase and B-phase signals received from resolver (101) into digital values to output a first AD converted value and a second AD converted value, respectively. Resolver digital converter (105) calculates angle data indicating an angle position in resolver (101) based on the input first AD converted value and second AD converted value. Resolver digital converter (105) outputs the calculated angle data.

### TECHNICAL FIELD

The present invention relates to an angular position detection device provided with a resolver that excites one phase to output two phases.

### BACKGROUND ART

Conventionally, a resolver is frequently used as means for detecting an angle position of a motor mainly in an industrial and electric fields.

The resolver is attached to a shaft included in the motor. The angle position of the motor is detected by the resolver. For example, as illustrated in FIG. 24, motor 113 is controlled based on the angle position detected by resolver 101.

FIG. 24 is a block diagram illustrating a conventional angular position detection device provided with the resolver.

A type in which one phase is excited to output two phases is adopted in resolver 101. Hereinafter, the type in which one phase is excited to output two phases is referred to as “one-phase excitation two-phase output”. Resolver 101 is attached to the shaft included in motor 113. Resolver 101 outputs an A-phase signal and a B-phase signal as a two-phase signal in which an amplitude is modulated. The A-phase and B-phase signals have a phase difference of about 90 degrees. Angular position detection device 1102 detects the angle position in resolver 101 based on the two-phase signal detected by resolver 101. Angular position detection device 1102 outputs the detected angle position in resolver 101 to servo amplifier 112. Servo amplifier 112 performs control and drive of motor 113 according to the detected angle position.

Angular position detection device 1102 outputs an excitation signal. The output excitation signal excites resolver 101 through buffer circuit 111.

An internal configuration of angular position detection device 1102 will be described below. First analog-digital converter 103 converts the A-phase analog signal output from resolver 101 into a digital value to output the digital value. Second analog-digital converter 104 converts the B-phase analog signal output from resolver 101 into a digital value to output the digital value. Hereinafter, the analog-digital converter is also referred to as an “AD converter” in some cases. Timing at which the analog signals are converted into the digital values follows a sampling instruction signal output from sampling instruction signal generator 1107. The A-phase signal converted into the digital value by first AD converter 103 and the B-phase signal converted into the digital value by second AD converter 104 are converted into a signal indicating the angle position in resolver 101 by resolver digital converter 105. Hereinafter, the resolver digital converter is also referred to as an “RD converter” in some cases. Generally methods such as tracking loop are used as a method for converting the digital value into the signal indicating the angle position in resolver 101. The A-phase and B-phase signals converted into signal indicating the angle position in resolver 101 are output to servo amplifier 112 through interface processor 110. Hereinafter, the interface processor is also referred to as an “IF processor” in some cases.

Servo amplifier 112 performs the control and drive of motor 113 according to the detected angle position in resolver 101, namely, the angle position of motor 113.

Sampling instruction signal generator 1107 adjusts a phase of the sampling instruction signal based on a reference signal output from reference signal generator 108. Sampling instruction signal generator 1107 outputs the sampling instruction signal in which the phase is adjusted to first AD converter 103 and second AD converter 104.

For example, Patent Literature 1 discloses the conventional angular position detection device.

FIG. 25 is a waveform chart illustrating signals in the conventional angular position detection device.

FIG. 25 illustrates the following waveforms. A waveform output from resolver 101 is indicated as A-phase signal 15a1. A waveform output from resolver 101 is indicated as B-phase signal 15a2. A waveform output from reference signal generator 108 is indicated as reference signal 15b.

Sampling instruction signal generator 1107 adjusts the phase of the sampling instruction signal based on reference signal 15b. Sampling instruction signal generator 1107 outputs the sampling instruction signal in which the phase is adjusted. As illustrated in FIG. 25, sampling instruction signal generator 1107 outputs the sampling instruction signal at times t1 and t3. Outputs of A-phase signal 15a1 and B-phase signal 15a2, which are output from resolver 101, reach the maximum at times t1 and t3.

The following method is also adopted as the method for finding out times t1 and t3. Times t2 and t4, at which the output of each signal is zero, are detected in A-phase signal 15a1 and B-phase signal 15a2. Times t1 and t3 are obtained by adding a time corresponding to a quarter of one cycle to detected times t2 and t4.

In this way, the angular position detection device performs the analog-digital conversion of A-phase signal 15a1 and B-phase signal 15a2 at timing at which the outputs of A-phase signal 15a1 and B-phase signal 15a2 reach the maximum. Consequently, the angular position detection device can output the resolver angle position.

### CITATION LIST

### Patent Literature

PTL 1: Unexamined Japanese Patent Publication No. 2011-33602

### SUMMARY OF THE INVENTION

An angular position detection device of the present invention includes a resolver, a sampling instruction signal generator, a first analog-digital converter, a second analog-digital converter, and a resolver digital converter.

The resolver outputs the A-phase signal having an amplitude modulated and B-phase signal having the phase difference of 90 degrees relative to the A-phase signal and having an amplitude modulated.

The following four phases exist in at least one of the A-phase and B-phase signals. It is assumed that a first phase is one in which magnitude of the signal is a minimum. It is assumed that a second phase is one in which magnitude of the signal is a maximum. It is assumed that a third phase is located at a middle in a change from the first phase to the second phase. It is assumed that a fourth phase is located at a middle in a change from the second phase to the first phase. The sampling instruction signal generator outputs a sampling instruction signal in each of the third and fourth phases.

The first analog-digital converter receives the A-phase signal when the sampling instruction signal is input, and converts the magnitude of the received A-phase signal into a digital value to generate a first AD converted value. The first analog-digital converter outputs the generated first AD converted value.

The second analog-digital converter receives the B-phase signal when the sampling instruction signal is input, and converts the magnitude of the received B-phase signal into a digital value to generate a second AD converted value. The second analog-digital converter outputs the generated second AD converted value.

The resolver digital converter receives the first converted value and second AD converted value, and calculates angle data indicating an angle position of the resolver based on the received first and second AD converted values. The resolver digital converter outputs the calculated angle data.

### BRIEF DESCRIPTION OF DRAWINGS

FIG. 1 is a block diagram illustrating a resolver angle detection device according to a first exemplary embodiment of the present invention.

FIG. 2 is a waveform chart illustrating signals in the first exemplary embodiment of the present invention.

FIG. 3 is a block diagram illustrating a resolver angle detection device according to a second exemplary embodiment of the present invention.

FIG. 4 is a block diagram illustrating an average value calculator of the second exemplary embodiment of the present invention.

FIG. 5 is a waveform chart illustrating signals in the second exemplary embodiment of the present invention.

FIG. 6 is a block diagram illustrating a specific example of the resolver angle detection device of the second exemplary embodiment of the present invention.

FIG. 7 is a block diagram illustrating an average value calculator of the second exemplary embodiment of the present invention.

FIG. 8 is a block diagram illustrating another specific example of the resolver angle detection device of the second exemplary embodiment of the present invention.

FIG. 9 is a block diagram illustrating an RD converter that is a comparative example in the second exemplary embodiment of the present invention.

FIG. 10 is a block diagram illustrating an RD converter of the second exemplary embodiment of the present invention.

FIG. 11 is a block diagram illustrating another average value calculator of the second exemplary embodiment of the present invention.

FIG. 12 is a block diagram illustrating a resolver angle detection device according to a third exemplary embodiment of the present invention.

FIG. 13 is a block diagram illustrating a sampling instruction signal generator of the third exemplary embodiment of the present invention.

FIG. 14 is a waveform chart illustrating signals in the third exemplary embodiment of the present invention.

FIG. 15 is a waveform chart illustrating a change in vector length difference in the third exemplary embodiment of the present invention.

FIG. 16 is a block diagram illustrating a resolver angle detection device according to a fourth exemplary embodiment of the present invention of the present invention.

FIG. 17 is a block diagram illustrating an excitation signal generator of the fourth exemplary embodiment of the present invention.

FIG. 18 is a block diagram illustrating another excitation signal generator of the fourth exemplary embodiment of the present invention.

FIG. 19 is a block diagram illustrating another resolver angle detection device of the fourth exemplary embodiment of the present invention.

FIG. 20 is a block diagram illustrating still another excitation signal generator of the fourth exemplary embodiment of the present invention.

FIG. 21 is a waveform chart illustrating signals in the fourth exemplary embodiment of the present invention.

FIG. 22 is a waveform chart illustrating other signals in the fourth exemplary embodiment of the present invention.

FIG. 23 is a waveform chart illustrating a change in vector length value in the fourth exemplary embodiment of the present invention.

FIG. 24 is a block diagram illustrating a conventional angle detection device provided with a resolver.

FIG. 25 is a waveform chart illustrating signals in the conventional angle detection device.

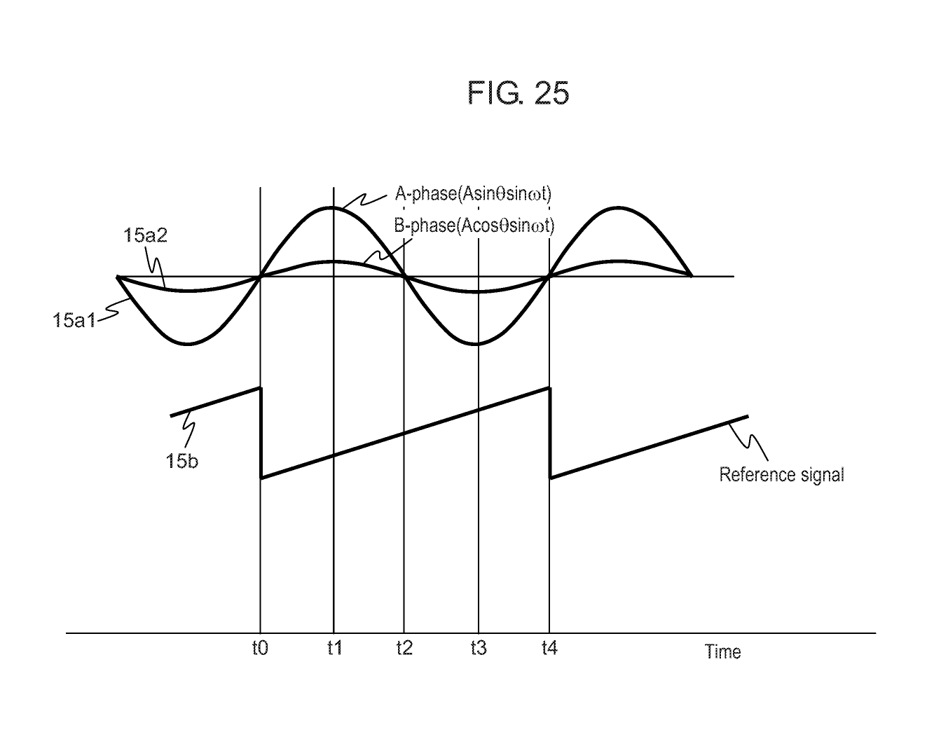

### DESCRIPTION OF EMBODIMENTS

An angular position detection device according to an exemplary embodiment of the present invention has good responsiveness and high detection accuracy by adopting the following configuration.

In particular, the angular position detection device of the exemplary embodiment of the present invention can adjust the signal output from the resolver at timing detected by the AD converter in detecting the angle position of the motor from the resolver through the AD converter. Specifically, the timing at which the AD converter detects the signal is adjusted by the sampling instruction signal. The sampling instruction signal can adjust the timing including fluctuation factors such as a variation in property of the resolver, a temperature change in surroundings of the resolver, and aging of the resolver. Therefore, the angular position detection device of the exemplary embodiment of the present invention can stably and accurately detect the angle position of the motor using the resolver.

The conventional angular position detection device has the following point to be improved. In the signal output from the resolver, the timing to maximize the output of the signal exists only twice in one cycle. For this reason, in the conventional angular position detection device, it is difficult that the responsiveness is enhanced to detect the angle position by shortening the sampling cycle of the signal output from the resolver.

The amplitude value of the resolver signal, which can be used to adjust the timing, exists only twice in one cycle in the case that the timing to output the sampling instruction signal is adjusted. This causes problems that adjustment accuracy of the timing to output the sampling instruction signal decreases or the adjustment time becomes longer.

Therefore, the exemplary embodiments of the present invention provide an angular position detection device provided with a resolver, and the angular position detection device is able to detect an angle position output from the resolver with high responsiveness. In the exemplary embodiments of the present invention, the timing to output the sampling instruction signal can be adjusted with high accuracy. Accordingly, the angular position detection device having the good responsiveness and the high detection accuracy can be provided.

Hereinafter, the exemplary embodiments of the present invention will be described with reference to the drawings. The following exemplary embodiments are described as a specific example of the present invention, but are not limited to a technical scope of the present invention.

### First Exemplary Embodiment

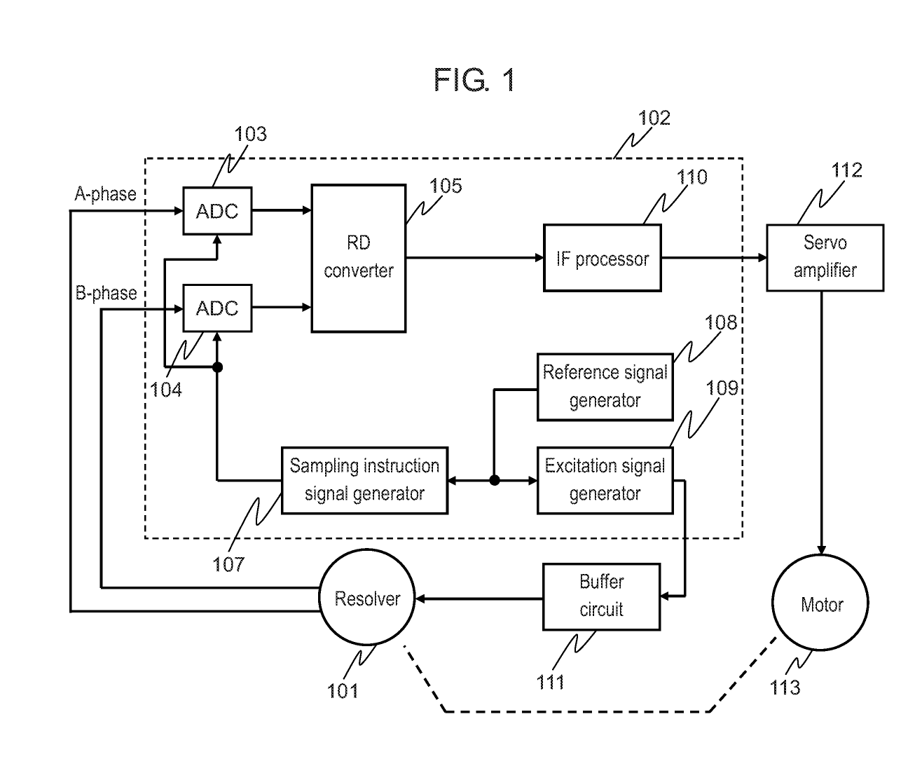

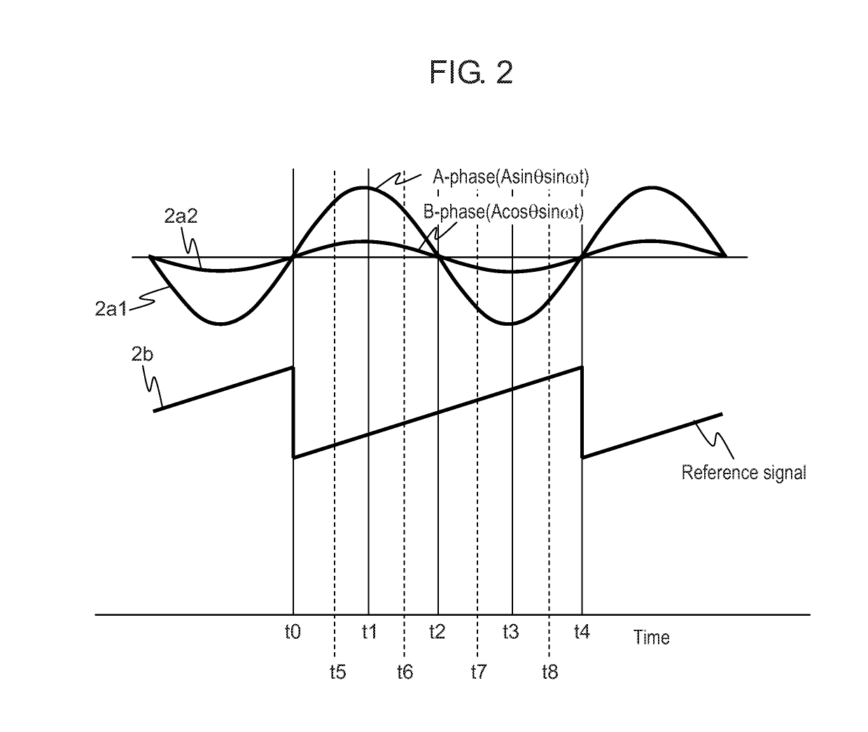

FIG. 1 is a block diagram illustrating a resolver angle detection device according to the first exemplary embodiment of the present invention. FIG. 2 is a waveform chart illustrating signals in the first exemplary embodiment of the present invention.

As illustrated in FIG. 1, angular position detection device 102 of the first exemplary embodiment of the present invention includes resolver 101, sampling instruction signal generator 107, first analog-digital converter 103, second analog-digital converter 104, and resolver digital converter 105.

Resolver 101 outputs an A-phase signal having an amplitude modulated and a B-phase signal having a phase difference of 90 degrees relative to the A-phase signal and having an amplitude modulated.

The following four phases exist in at least one of the A-phase and B-phase signals. It is assumed that a first phase is one at which magnitude of the A-phase signal or B-phase signal is at the minimum. It is assumed that a second phase is one at which the magnitude of the A-phase signal or B-phase signal is at the maximum. It is assumed that a third phase is located at a middle time in a change from the first phase to the second phase. It is assumed that a fourth phase is located at a middle time in a change from the second phase to the first phase. Sampling instruction signal generator 107 outputs a sampling instruction signal in each of the third phase and fourth phase.

First analog-digital converter 103 receives the A-phase signal when the sampling instruction signal is input, and converts the magnitude of the received A-phase signal into a digital value to generate a first AD converted value. First analog-digital converter 103 outputs the generated first AD converted value.

Second analog-digital converter 104 receives the B-phase signal when the sampling instruction signal is input, and converts the magnitude of the received B-phase signal into a digital value to generate a second AD converted value. Second analog-digital converter 104 outputs the generated second AD converted value.

Resolver digital converter 105 receives the first AD converted value and the second AD converted value, and calculates angle data indicating an angle position in resolver 101 based on the received first AD converted value and second AD converted value. Resolver digital converter 105 outputs the calculated angle data.

In the A-phase and B-phase signals, the magnitude of the signal can be replaced with an absolute value of the signal.

In the above configuration, in one cycle of the signal output from the resolver, the number of sampling times that can effectively be performed can be increased to four times that is double of two times as the conventional number of sampling times. Therefore, a sampling period can be shortened to a half of a conventional period. Additionally, the sampling can be performed with an equal amplitude at each sampling timing. Consequently, the resolver angular position detection device of the first exemplary embodiment has the high responsiveness and the high accuracy.

The description will further be made in detail.

As illustrated in FIG. 1, resolver 101 is a one-phase excitation two-phase output type, and is attached to a shaft included in motor 113. Resolver 101 outputs signals having two phases, one of the signals is referred to as the A-phase signal, and the other is referred to as the B-phase signal. The A-phase and B-phase signals are amplitude-modulated and have a phase difference of about 90 degrees with respect to each other.

Angular position detection device 102 for resolver 101 detects the angle position in resolver 101 from the signals having the two phases, and outputs the angle position to servo amplifier 112. Servo amplifier 112 performs control and drive of motor 113 according to the angle position detected by angular position detection device 102. Angular position detection device 102 for resolver 101 outputs an excitation signal to resolver 101 through buffer circuit 111 to excite resolver 101.

An internal configuration of angular position detection device 102 for resolver 101 will be described below.

First analog-digital converter 103 converts the A-phase analog signal output from resolver 101 into a digital value. Second analog-digital converter 104 converts the B-phase analog signal output from resolver 101 into a digital value. Timing at which first AD converter 103 and second AD converter 104 convert the analog signals into the digital values follows the sampling instruction signal output from sampling instruction signal generator 107.

Resolver digital converter 105 converts the signals, which are converted into the digital values by first AD converter 103 and second AD converter 104, into a signal indicating the angle position in resolver 101. Generally methods such as tracking loop are used as the method for converting the signal converted into the digital value into the signal indicating the angle position in resolver 101. The signal indicating the angle position in resolver 101 is output to servo amplifier 112 through interface processor 110.

Servo amplifier 112 performs the control and drive of motor 113 according to the detected angle position in resolver 101, namely, the angle position of motor 113.

At a predetermined phase, sampling instruction signal generator 107 outputs the sampling instruction signal to first AD converter 103 and second AD converter 104 based on the reference signal output from reference signal generator 108.

Excitation signal generator 109 generates the excitation signal based on the reference signal output from reference signal generator 108, and outputs the generated excitation signal.

The resolver angular position detection device having the above configuration acts as the control device of the motor. Operation and action of the resolver angular position detection device will be described below.

FIG. 2 illustrates the A-phase and B-phase signals and the like, which are output from resolver 101. A-phase signal 2a1 and B-phase signal 2a2 in FIG. 2 are signals in which each of which is the excitation signal (sin ωt) amplitude-modulated in resolver 101. A-phase signal 2a1 and B-phase signal 2a2 have the phase difference of 90 degrees relative to each other and are amplitude-modulated. Assuming that θ is the angle position in resolver 101, A-phase signal 2a1 is expressed by A sin θ sin ωt, and B-phase signal 2a2 is expressed by A cos θ sin ωt, where A is the amplitude in the signal of each phase.

Reference signal 2b in FIG. 2 is output from reference signal generator 108. Excitation signal generator 109 generates the excitation signal based on input reference signal 2b. Reference signal 2b is repeatedly output at the same cycle as A-phase signal 2a1 and B-phase signal 2a2, which are output from resolver 101.

The amplitudes of A-phase signal 2a1 and B-phase signal 2a2, which are output from resolver 101, are zero at times t0 and t4 at which reference signal 2b is zero and time t2 in the middle between times t0 and t4.

At this point, the amplitudes of A-phase signal 2a1 and B-phase signal 2a2, which are output from resolver 101, reach the maximum at time t1 in the middle between times t0 and t2 and time t3 in the middle between times t2 and t4.

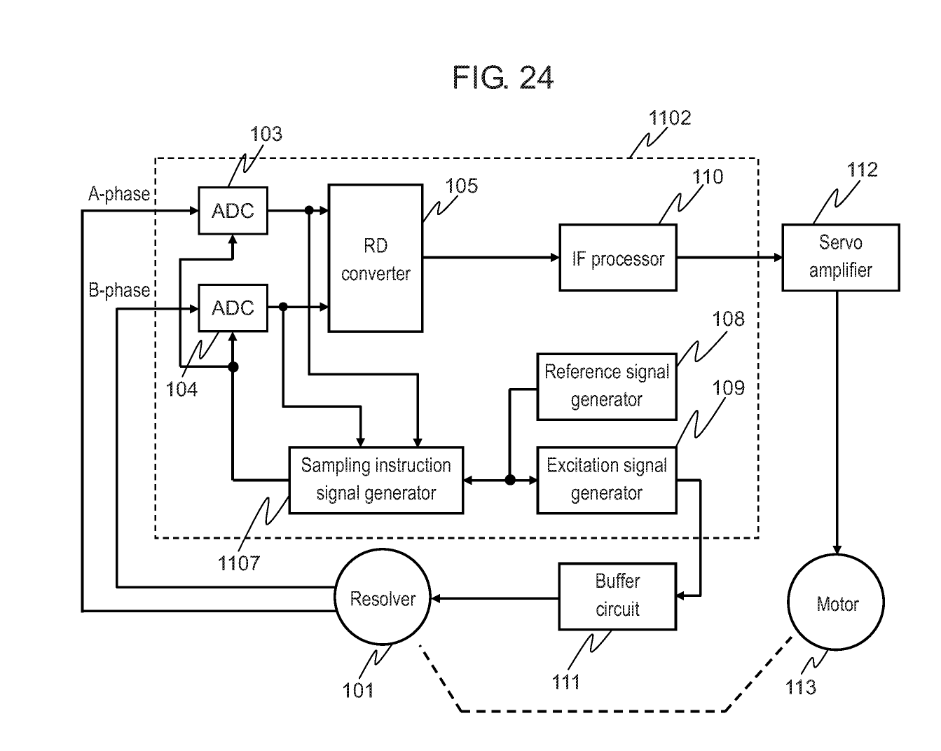

As illustrated in FIG. 24, in the conventional system, sampling instruction signal generator 1107 outputs the sampling instruction signal at times t1 and t3. First AD converter 103 and second AD converter 104, to which the sampling instruction signals are input, converts the signal output from resolver 101 into the digital value, and outputs the amplitude of each signal to RD converter 105. RD converter 105 performs conversion processing of deriving the angle position in resolver 101 from the input amplitude of each signal.

However, in the conventional type, a sampling opportunity exists only twice with respect to the excitation signal in one cycle period. Similarly, an opportunity to update each signal input to RD converter 105 exists only twice with respect to the one-cycle period of the excitation signal. In the conventional system, it is difficult to improve the responsiveness.

Therefore, in angular position detection device 102 of the first exemplary embodiment of the present invention, sampling instruction signal generator 107 outputs the sampling instruction signal at the later-described time indicated by a dotted line in FIG. 2. That is, the time indicated by the dotted lines are time t5 in the middle between times t0 and t1, time t6 in the middle between times t1 and t2, time t7 in the middle between times t2 and t3, and time t8 in the middle between times t3 and t4. At each time, the amplitudes of A-phase signal 2a1 and B-phase signal 2a2, which are converted into the digital values by first AD converter 103 and second AD converter 104, are input to RD converter 105. RD converter 105 performs conversion processing of deriving the angle position in resolver 101 from the input amplitudes.

The conversion processing increases the sampling opportunity to four times with respect to the one-cycle period of the excitation signal. Additionally, A-phase signal 2a1 and B-phase signal 2a2 are detected with an equal amplitude in each sampling opportunity.

Therefore, angular position detection device 102 of the first exemplary embodiment of the present invention can obtain the responsiveness that is double comparing to the conventional type without degrading the detection accuracy of the angle position when the amplitudes of A-phase signal 2a1 and B-phase signal 2a2, which are detected at each sampling opportunity and input to RD converter 105, are subjected to the conversion processing into the angle position in resolver 101.

In other words, sampling instruction signal generator 107 outputs the sampling instruction signal in the phase located substantially in the middle between the phases in which the magnitudes of A-phase signal 2a1 and B-phase signal 2a2, namely, absolute values of signals 2a1 and 2a2 reach the maximum and the minimum respectively. RD converter 105 performs the conversion processing for deriving the angle positions of resolver 101 from the digital values output by first AD converter 103 and second AD converter 104 at each timing to output the sampling instruction signal. Consequently, the period in which the conversion processing is performed is shortened to a half compared with the conventional type. Additionally, at each detection opportunity, A-phase signal 2a1 and B-phase signal 2a2 are sampled with the equal amplitude. Therefore, in angular position detection device 102 of the first exemplary embodiment of the present invention, the angle position in resolver 101 can accurately be detected with good response performance.

### Second Exemplary Embodiment

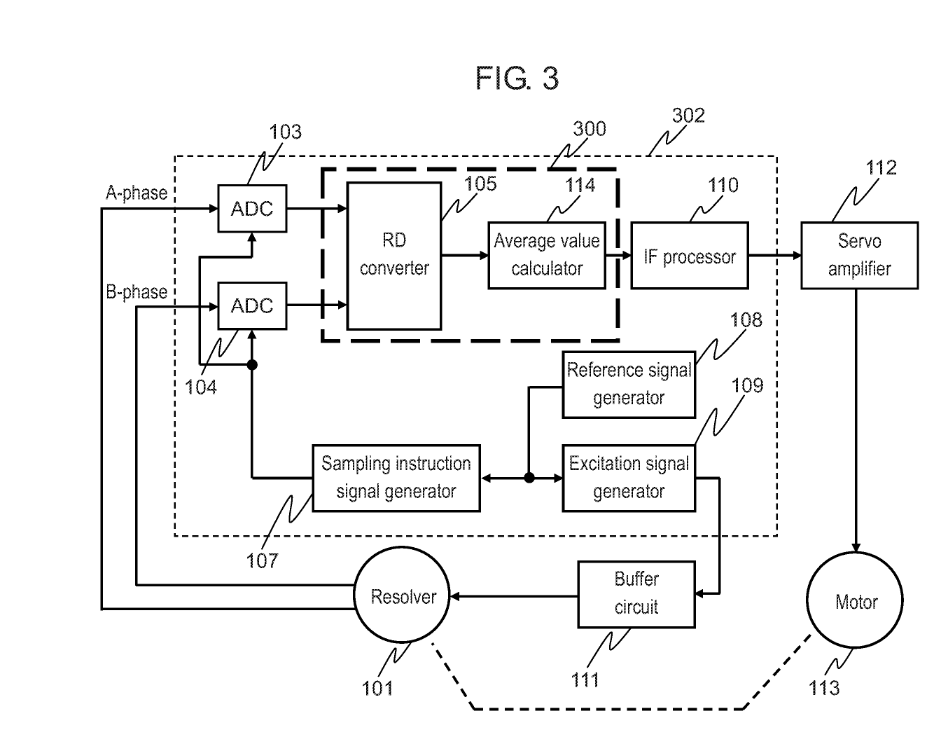

FIG. 3 is a block diagram illustrating a resolver angle detection device according to a second exemplary embodiment of the present invention.

The angular position detection device of the second exemplary embodiment differs from the angular position detection device of the first exemplary embodiment with respect to the resolver digital converter. Specifically, the angular position detection device of the second exemplary embodiment includes a resolver digital converter having a function of performing averaging processing.

The angular position detection device of the second exemplary embodiment will be described below with reference to FIGS. 3 to 11.

The component having the same configuration as the first exemplary embodiment is designated by the same reference mark, and the explanation is omitted.

As illustrated in FIG. 3, angular position detection device 302 of the second exemplary embodiment of the present invention includes average resolver digital converter 300 instead of resolver digital converter 105 in angular position detection device 102 of the first exemplary embodiment. Average resolver digital converter 300 includes average value calculator 114 and resolver digital converter 105.

The first AD converted value output from first analog-digital converter 103 is called a past first AD converted value.

The first AD converted value, which is newly output from first analog-digital converter 103 in response to the sampling instruction output from sampling instruction signal generator 107 in a fourth phase generated immediately after a third phase or the third phase generated immediately after the fourth phase, is called a new first AD converted value.

The second AD converted value output from second analog-digital converter 104 is called a past second AD converted value.

The second AD converted value, which is newly output from second analog-digital converter 104 in response to the sampling instruction output from sampling instruction signal generator 107 in the fourth phase generated immediately after the third phase or the third phase generated immediately after the fourth phase, is called a new second AD converted value.

Then, the angle data indicating the angle position in resolver 101 is calculated using the past first AD converted value, the new first AD converted value, the past second AD converted value, and the new second AD converted value. In a process of calculating the angle data indicating the angle position in resolver 101, average value calculator 114 performs the averaging processing using at least two of the past first AD converted value, the new first AD converted value, the past second AD converted value, and the new second AD converted value.

Resolver digital converter 105 calculates the angle data based on at least two of the past first AD converted value, the new first AD converted value, the past second AD converted value, and the new second AD converted value, and outputs the calculated angle data.

The configuration can cancel an angle detection error. The angle detection error is caused by a phase shift included in the two-phase signal output from resolver 101. Therefore, angular position detection device 302 of the second exemplary embodiment can easily perform the high-accuracy angle position detection.

Three modes in which average value calculator 114 is attached to a different position relative to resolver digital converter 105 in average resolver digital converter 300 will be described below. The three cases include 1. the case where the average value calculator is located on the output side of the resolver digital converter, 2. the case where the average value calculator is located on the input side of the resolver digital converter, and 3. the case where the average value calculator is located in the resolver digital converter.

1. The Case where the Average Value Calculator is Located on the Output Side of the Resolver Digital Converter:

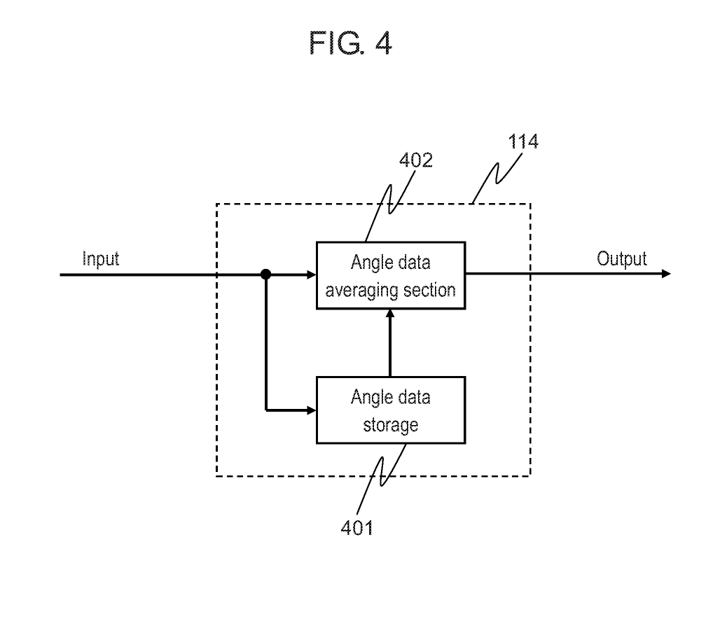

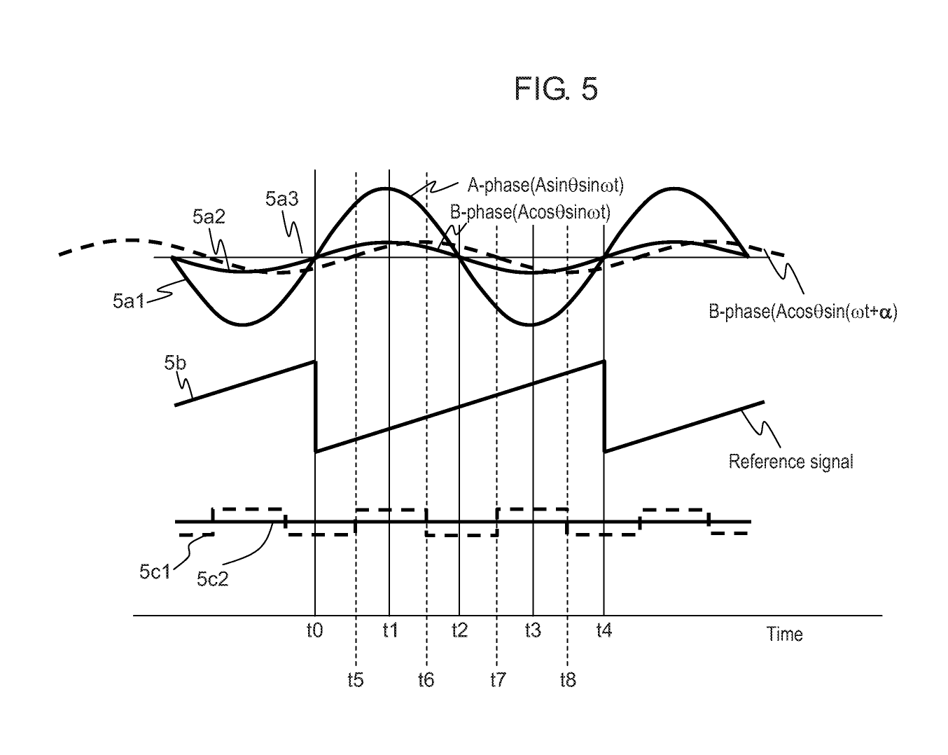

FIG. 4 is a block diagram illustrating the average value calculator of the second exemplary embodiment of the present invention. FIG. 5 is a waveform chart illustrating signals in the second exemplary embodiment of the present invention.

As illustrated in FIG. 3, angular position detection device 302 of the mode 1 is provided with average resolver digital converter 300 including resolver digital converter 105 and average value calculator 114.

The first AD converted value and the second AD converted value are input to resolver digital converter 105. Resolver digital converter 105 calculates the angle data indicating the angle position in resolver 101 based on the input first AD converted value and second AD converted value. Resolver digital converter 105 outputs the calculated angle data.

As illustrated in FIG. 4, average value calculator 114 includes angle data storage 401 and angle data averaging section 402.

Angle data storage 401 stores the angle data, which is output from resolver digital converter 105 in response to the sampling instruction output from sampling instruction signal generator 107 in the third phase or the fourth phase. Angle data storage 401 stores the angle data, which is newly output from resolver digital converter 105 in response to the sampling instruction output from sampling instruction signal generator 107 in the fourth phase generated immediately after the third phase or the third phase generated immediately after the fourth phase, instead of the stored angle data.

Angle data averaging section 402 receives, as new angle data, the angle data, which is output from resolver digital converter 105 in response to the sampling instruction output from sampling instruction signal generator 107 in the fourth phase generated immediately after the third phase or the third phase generated immediately after the fourth phase. Angle data averaging section 402 receives, as past angle data, the angle data, which is stored in angle data storage 401 before the third phase or the fourth phase. Angle data averaging section 402 calculates an average value of the past angle data and the new angle data, and outputs the calculated average value.

The detailed description is further made with reference to the drawings.

As illustrated in FIG. 3, angular position detection device 302 for resolver 101 differs from angular position detection device 102 of the first exemplary embodiment in that RD converter 105 is replaced with average resolver digital converter 300. More exactly, angular position detection device 302 for resolver 101 differs from angular position detection device 102 of the first exemplary embodiment in that average value calculator 114 is added onto the output side of RD converter 105 in angular position detection device 102 of the first exemplary embodiment. Hereinafter, the average resolver digital converter is referred to as an “average RD converter” in some cases.

Average value calculator 114 will be described below with reference to FIG. 4.

As illustrated in FIG. 4, average value calculator 114 stores the input signal in angle data storage 401. In the second exemplary embodiment, the angle data of the input signal only for one-time sampling is stored in angle data storage 401.

After the one-time sampling, the angle data of the new signal is input to average value calculator 114. At this point, angle data storage 401 outputs the angle data, which is stored in the last one-time sampling, as past angle data to angle data averaging section 402. The angle data of the newly-input signal is stored as new angle data in angle data storage 401.

Angle data averaging section 402 calculates the average value using the new angle data input from RD converter 105 and the past angle data input from angle data storage 401. Angle data averaging section 402 outputs the calculated average value.

A reason and an effect of the addition of average value calculator 114 in angular position detection device 302 for resolver 101 will be described below, average resolver digital converter 300 being included in angular position detection device 302.

FIG. 5 illustrates the A-phase and B-phase signals and the like, which are output from resolver 101.

Similarly to the first exemplary embodiment, it is assumed that sin ωt is the excitation signal, that θ is the angle position in resolver 101, and that A is the amplitude of the signal. At this point, as illustrated in FIG. 5, A-phase signal 5a1 is expressed by A sin θ sin ωt, and B-phase signal 5a2 is expressed by A cos θ sin ωt. FIG. 5 also illustrates reference signal 5b.

The A-phase and B-phase signals have the slight phase shift relative to each other. It is assumed that a is the phase shift. When the phase shift is considered, A-phase signal 5a1 is expressed by A sin θ sin ωt, and B-phase signal 5a3 is expressed by A cos θ sin(ωt+α). Generally phase shift a has a value of about ±0.1 degree.

An effect of the case where slight phase shift a exists between A-phase signal 5a1 and B-phase signal 5a3 will be described compared with the first exemplary embodiment.

In the case where angular position detection device 102 of the first exemplary embodiment that does not include average value calculator 114 is used, the output value of RD converter 105 fluctuates in each time of the sampling in which the sampling instruction signal is output. As illustrated in FIG. 5, output value 5c1 of the RD converter is indicated by a dotted line.

A fluctuation width of output value 5c1 of the RD converter increases as the amplitudes of the A-phase and B-phase signals come close to each other. At most the fluctuation width is a width of phase shift a. Assuming that phase shift a is 0.1 degree, the fluctuation width is 6 minutes.

This phenomenon is disadvantageous in the application where the fast response performance and the high accuracy are required to detect the angle position in resolver 101.

Therefore, as illustrated in FIG. 3, angular position detection device 302 including average value calculator 114 is used. At this point, the fluctuation is canceled in the output value of average RD converter 300. As illustrated in FIG. 5, output value 5c2 of average RD converter is indicated by a solid line that is a flat waveform by cancelling the fluctuation.

Average value calculator 114 averages the values of the angle positions in resolver 101 detected before and after the one-time sampling. The value averaged by average value calculator 114 is output as the angle position in resolver 101. The use of the averaged output value can accurately detect the angle position in resolver 101 with good response performance.

In the above explanation, the angle data only for the one-time sampling is stored in angle data storage 401 and updated to the new angle data at anytime, and the new angle data is stored in angle data storage 401.

The angle data stored in angle data storage 401 is not limited to the angle data for one-time sampling, but the angle data for a predetermined plurality of times of the sampling may be stored.

When the angle data for one-time sampling is stored in angle data storage 401, the calculation speed by angle data averaging section 402 increases and thus the response performance is improved. On the other hand, in the case where the angle data for the plurality of times of the sampling is stored in angle data storage 401, the accuracy of the average value calculated by angle data averaging section 402 is improved.

In angular position detection device 302 for the resolver in FIG. 3, the degradation of the response performance slightly occurs compared with angular position detection device 102 for resolver 101 in FIG. 1. However, angular position detection device 302 for resolver 101 in FIG. 3 has the response performance faster than conventional angular position detection device 1102 for resolver 101 in FIG. 24 by about 1.5 times.

As for the amplitudes of the A-phase and B-phase signals, in the phase substantially located in the middle between the phase where the absolute value is the maximum and the phase where the absolute value is the minimum, the amplitudes of the A-phase and B-phase signals which are output from resolver 101 are about 0.7 time relative to the maximum value. However, as described above, an SN ratio is improved in angular position detection device 302 of the second exemplary embodiment by averaging the output values of the detected angle position in resolver 101. Therefore, the effect of the present invention can comprehensively ensure the sufficient superiority.

2. The Case where the Average Value Calculator is Located on the Input Side of the Resolver Digital Converter:

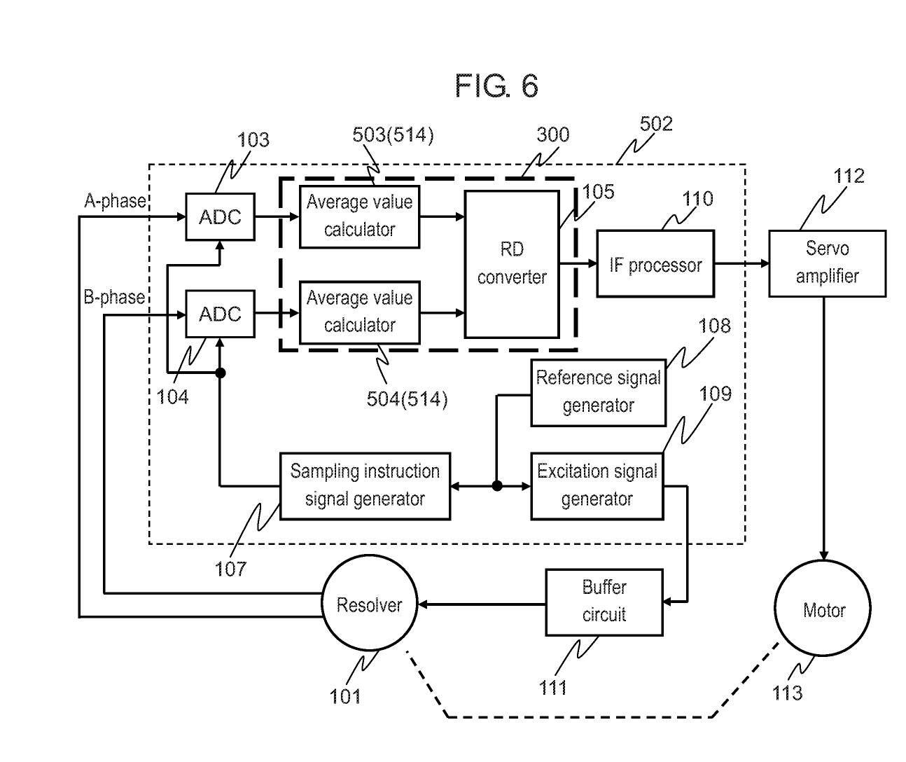

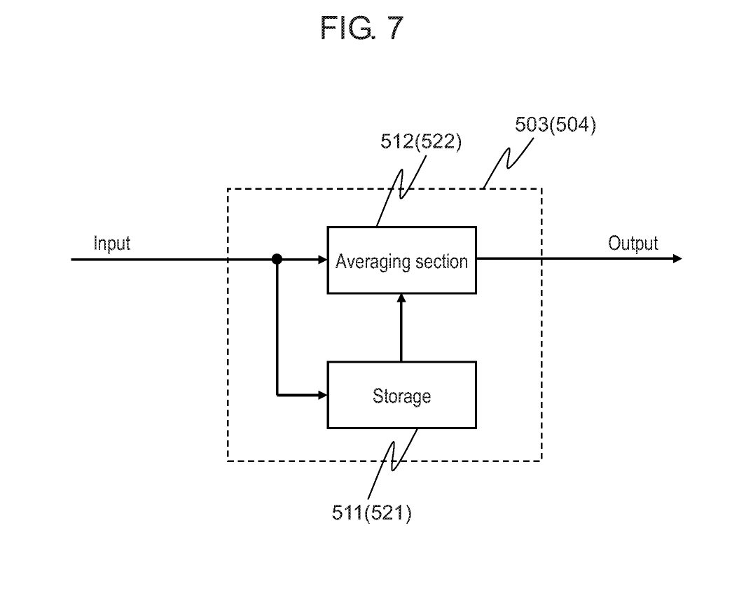

FIG. 6 is a block diagram illustrating a specific example of the resolver angle detection device of the second exemplary embodiment of the present invention. FIG. 7 is a block diagram illustrating the average value calculator of the second exemplary embodiment of the present invention.

As illustrated in FIG. 6, angular position detection device 502 of the case 2 is provided with average resolver digital converter 300 including resolver digital converter 105 and average value calculator 514.

Average value calculator 514 includes A-phase average value calculator 503 and B-phase average value calculator 504.

As illustrated in FIG. 7, A-phase average value calculator 503 includes first AD converted value storage 511 and first AD converted value averaging section 512.

As illustrated in FIGS. 6 and 7, first AD converted value storage 511 stores the first AD converted value, which is output from first analog-digital converter 103 in response to the sampling instruction output from sampling instruction signal generator 107 in the third phase or the fourth phase. First AD converted value storage 511 stores, the first AD converted value, which is newly output from first analog-digital converter 103 in response to the sampling instruction output from sampling instruction signal generator 107 in the fourth phase generated immediately after the third phase or the third phase generated immediately after the fourth phase, as the new first AD converted value, instead of the stored first AD converted value.

First AD converted value averaging section 512 receives, the first AD converted value, which is output from first analog-digital converter 103 in response to the sampling instruction output from sampling instruction signal generator 107 in the fourth phase generated immediately after the third phase or the third phase generated immediately after the fourth phase, as the new first AD converted value. First AD converted value averaging section 512 receives, the first AD converted value, which is stored in first AD converted value storage 511 before the third phase or the fourth phase, as the past first AD converted value. First AD converted value averaging section 512 calculates the average value of the past first AD converted value and the new first AD converted value, and outputs the calculated average value as an averaged first AD converted value.

B-phase average value calculator 504 includes second AD converted value storage 521 and second AD converted value averaging section 522.

Second AD converted value storage 521 stores the second AD converted value, which is output from second analog-digital converter 104 in response to the sampling instruction output from sampling instruction signal generator 107 in the third phase or the fourth phase. Second AD converted value storage 521 stores the second AD converted value, which is newly output from second analog-digital converter 104 in response to the sampling instruction output from sampling instruction signal generator 107 in the fourth phase generated immediately after the third phase or the third phase generated immediately after the fourth phase, instead of the stored second AD converted value, as the new second AD converted value.

Second AD converted value averaging section 522 receives, as the new second AD converted value, the second AD converted value, which is output from second analog-digital converter 104 in response to the sampling instruction output from sampling instruction signal generator 107 in the fourth phase generated immediately after the third phase or the third phase generated immediately after the fourth phase. Second AD converted value averaging section 522 receives, as the past second AD converted value, the second AD converted value, which is stored in second AD converted value storage 521 before the third phase or the fourth phase. Second AD converted value averaging section 522 calculates the average value of the past second AD converted value and the new second AD converted value, and outputs the calculated average value as an averaged second AD converted value.

Resolver digital converter 105 receives the averaged first AD converted value and the averaged second AD converted value. Resolver digital converter 105 calculates the angle data indicating the angle position in resolver 101 based on the received averaged first AD converted value and the averaged second AD converted value. Resolver digital converter 105 outputs the calculated angle data.

The detailed description is further made with reference to the drawings.

As illustrated in FIG. 6, angular position detection device 502 for resolver 101 differs from angular position detection device 102 of the first exemplary embodiment in that RD converter 105 is replaced with average resolver digital converter 300. More exactly, the difference is that average value calculator 514 is added onto the input side of RD converter 105 in angular position detection device 102 of the first exemplary embodiment. Average value calculator 514 includes A-phase average value calculator 503 and B-phase average value calculator 504.

A-phase average value calculator 503 and B-phase average value calculator 504 will be described below with reference to FIG. 7. A-phase average value calculator 503 and B-phase average value calculator 504 have the function similar to that of average value calculator 114 of the mode 1. Therefore, A-phase average value calculator 503 will be described below as an example. The description of A-phase average value calculator 503 is cited for B-phase average value calculator 504.

A-phase average value calculator 503 stores the input signal in first AD converted value storage 511. In the second exemplary embodiment, first AD converted value storage 511 stores therein the first AD converted value of the input signal only for one-time sampling.

After the one-time sampling, the first AD converted value, that is the new signal, is input to A-phase average value calculator 503. At this point, first AD converted value storage 511 outputs the first AD converted value, which is stored in the last one-time sampling, to first AD converted value averaging section 512, as the past first AD converted value. First AD converted value storage 511 stores therein the first AD converted value that is the newly-input signal, as the new first AD converted value.

First AD converted value averaging section 512 calculates the average value using the new first AD converted value input from first AD converter 103 and the past first AD converted value input from first AD converted value storage 511. First AD converted value averaging section 512 outputs the calculated average value.

In angular position detection device 502 for the resolver in FIG. 6, the A-phase signal converted into the digital value by first AD converter 103 is input to A-phase average value calculator 503. After the averaging processing, the averaged first AD converted value is input to RD converter 105.

Similarly, the B-phase signal converted into the digital value by second AD converter 104 is input to B-phase average value calculator 504. After the averaging processing, the averaged second AD converted value is input to RD converter 105.

As for angular position detection device 502 having average resolver digital converter 300 above-described, the reason and effect of the addition of A-phase average value calculator 503 and B-phase average value calculator 504 as average value calculator 514 will be described below with reference to FIG. 5.

The following description has contents based on the case 1.

A-phase signal 5a1 and B-phase signal 5a2, output from resolver 101, have the slight phase shift relative to each other. At this point, as described in the mode 1, in the case where angular position detection device 102 of the first exemplary embodiment that does not include average value calculator 114 is used, the output value of RD converter 105 fluctuates in each one sampling in which the sampling instruction signal is output. As illustrated in FIG. 5, output value 5c1 of the RD converter is indicated by a dotted line.

This phenomenon is disadvantageous in the application where the fast response performance and the high accuracy are required to detect the angle position in resolver 101.

Therefore, angular position detection device 502 including A-phase average value calculator 503 and B-phase average value calculator 504, which are of average value calculator 514, is used as illustrated in FIG. 6. At this point, the fluctuation is canceled in the output value of average RD converter 300. As illustrated in FIG. 5, output value 5c2 of average RD converter is indicated by a solid line, where output value 5c2 has a flat waveform in which the fluctuation is canceled.

A-phase average value calculator 503 and B-phase average value calculator 504, which are of average value calculator 514, average the values of which the angle position in resolver 101 is detected before and after the one-time sampling. The values averaged by A-phase average value calculator 503 and B-phase average value calculator 504, which are of average value calculator 514, are output as the angle position in resolver 101. By use of the averaged output value, the angle position in resolver 101 can be accurately detected with good response performance.

In the above description, the first AD converted value only for the one-time sampling is stored in first AD converted value storage 511 and updated to the new first AD converted value at anytime, and the new first AD converted value is stored in first AD converted value storage 511.

The first AD converted value stored in first AD converted value storage 511 is not limited to the first AD converted value for one-time sampling, but the first AD converted value for the plurality of times of the sampling may be stored.

When the first AD converted value for one-time sampling is stored in first AD converted value storage 511, the calculation speed by first AD converted value averaging section 512 increases and thus the response performance is improved. On the other hand, when the first AD converted value for the plurality of times of the sampling is stored in first AD converted value storage 511, the accuracy of the average value calculated by first AD converted value averaging section 512 is improved.

In angular position detection device 502 for resolver 101 in FIG. 6, the degradation of the response performance slightly occurs compared with angular position detection device 102 for resolver 101 in FIG. 1. However, angular position detection device 502 for resolver 101 in FIG. 6 has the response performance faster than conventional angular position detection device 1102 for resolver 101 in FIG. 24 by about 1.5 times.

As for the amplitudes of the A-phase and B-phase signals, in the phase substantially located in the middle between the phase where the absolute value is the maximum and the phase where the absolute value is the minimum, the amplitudes of the A-phase and B-phase signals which are output from resolver 101 are about 0.7 time relative to the maximum value. However, as described above, an SN ratio is improved in angular position detection device 502 of the second exemplary embodiment by averaging the output values of the detected angle position in resolver 101 is detected. Therefore, the effect of the present invention can comprehensively ensure the sufficient superiority.

3. The Case where the Average Value Calculator is Located in the Resolver Digital Converter

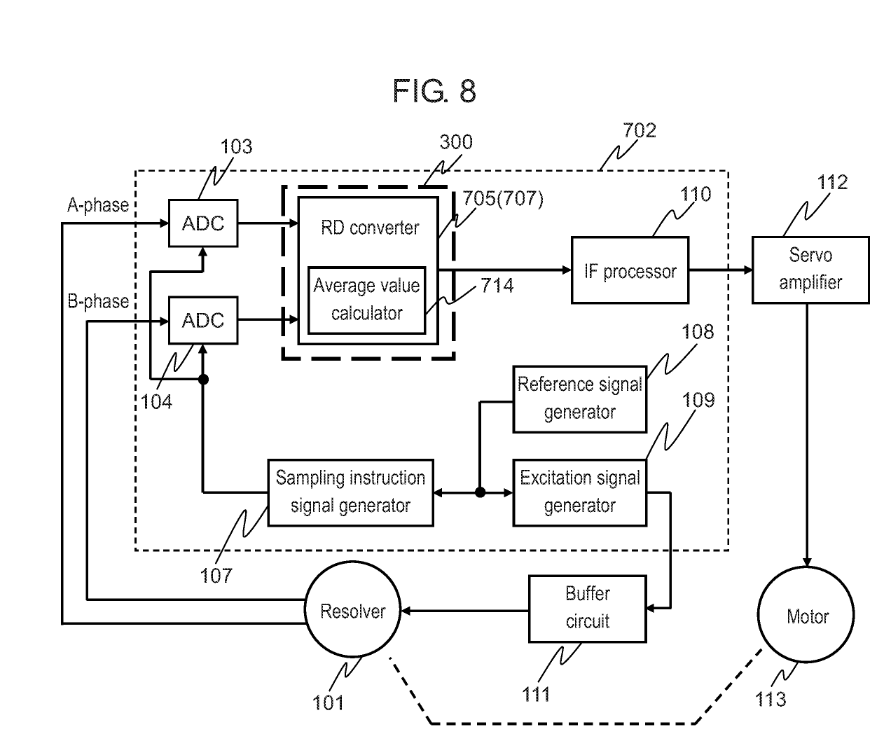

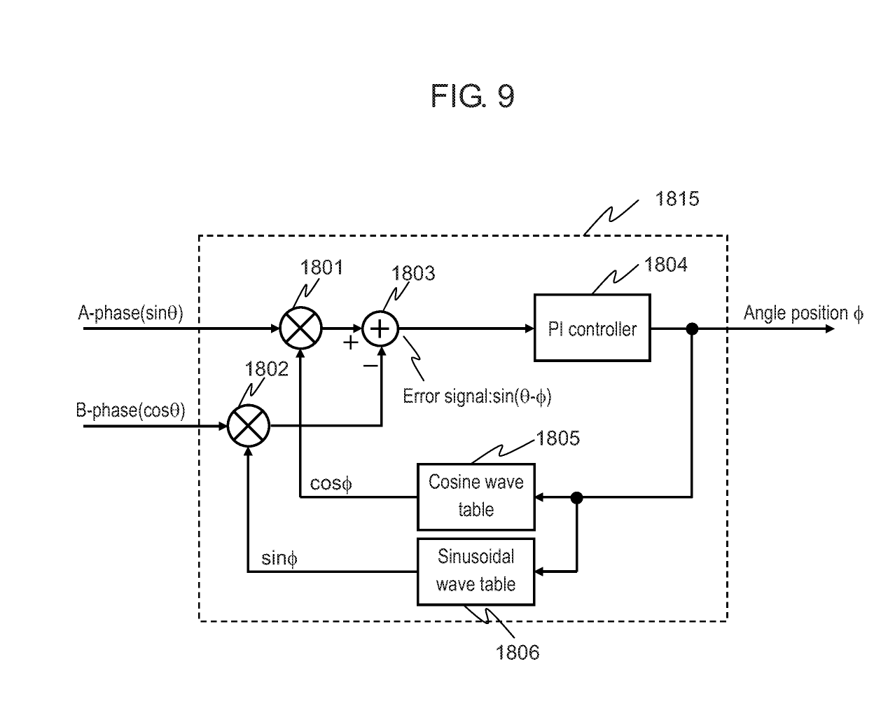

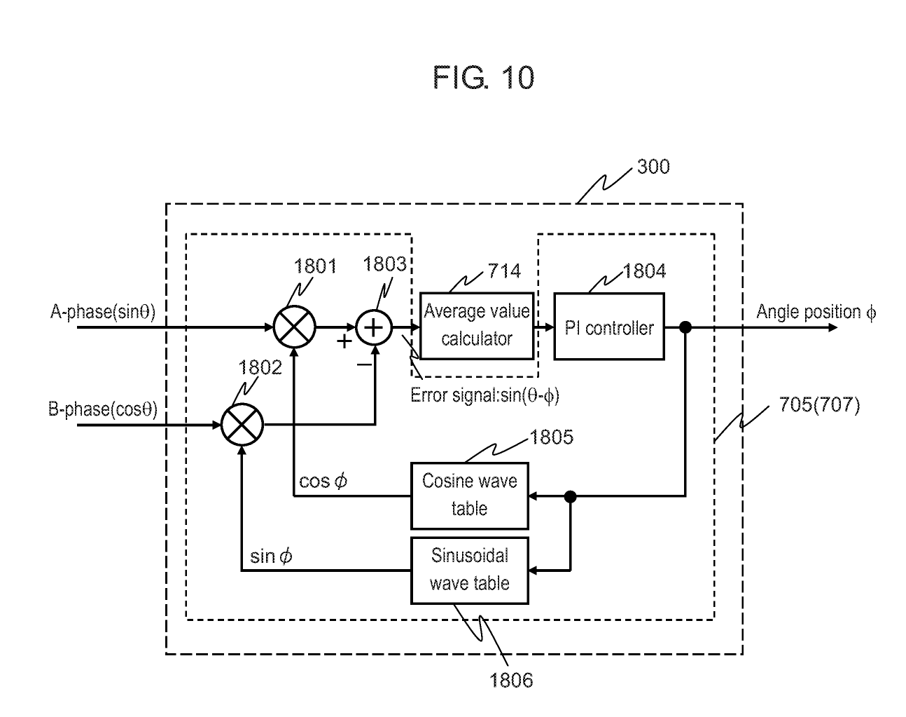

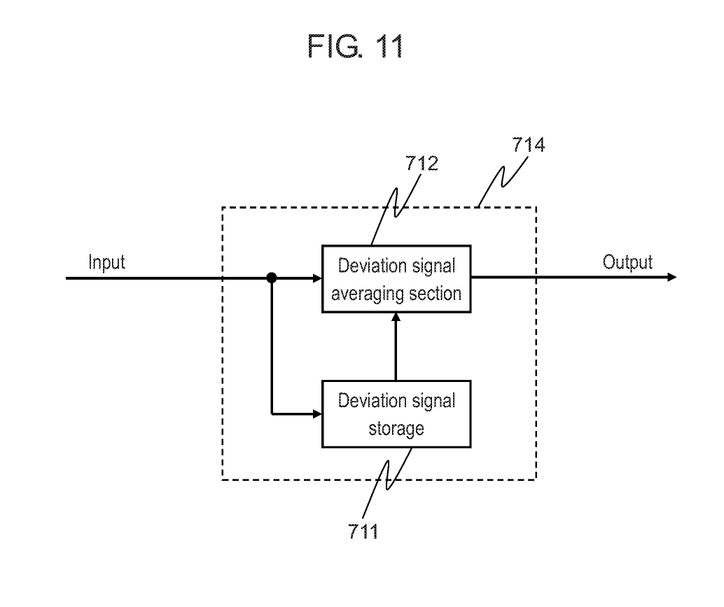

FIG. 8 is a block diagram illustrating another specific example of the resolver angle detection device of the second exemplary embodiment of the present invention. FIG. 9 is a block diagram illustrating an RD converter that is of a comparative example in the second exemplary embodiment of the present invention. FIG. 10 is a block diagram illustrating an RD converter of the second exemplary embodiment of the present invention. FIG. 11 is a block diagram illustrating another average value calculator of the second exemplary embodiment of the present invention.

As illustrated in FIG. 8, angular position detection device 702 of the case 3 is provided with average resolver digital converter 300 including resolver digital converter 705 and average value calculator 714.

When resolver digital converter 705 receives the first and second AD converted values, resolver digital converter 705 calculates angle position φ in resolver 101 from rotation angle θ in resolver 101 based on the received first and second AD converted values. In this case, resolver digital converter 705 includes tracking loop 707. Tracking loop 707 calculates deviation signal sin(θ−φ) from the input first and second AD converted values, and causes the calculated deviation signal sin(θ−φ) to converge to zero to calculate angle position φ of resolver 101. Resolver digital converter 705 outputs the angle data from calculated angle position φ.

As illustrated in FIG. 11, average value calculator 714 includes deviation signal storage 711 and deviation signal averaging section 712.

Deviation signal storage 711 stores the deviation signal, which is calculated by tracking loop 707 in response to the sampling instruction output from sampling instruction signal generator 107 in the third phase or the fourth phase, as illustrated in FIGS. 8 and 11. Deviation signal storage 711 stores the deviation signal, which is newly calculated by tracking loop 707 in response to the sampling instruction output from sampling instruction signal generator 107 in the fourth phase generated immediately after the third phase or the third phase generated immediately after the fourth phase, as a new deviation signal, instead of the stored deviation signal.

Deviation signal averaging section 712 receives the deviation signal, which is calculated by tracking loop 707 in response to the sampling instruction output from sampling instruction signal generator 107 in the fourth phase generated immediately after the third phase or the third phase generated immediately after the fourth phase, as new deviation signal. Deviation signal averaging section 712 receives the deviation signal, which is stored in deviation signal storage 711 before the third phase or the fourth phase, as a past deviation signal. Deviation signal averaging section 712 calculates the average value of the past deviation signal and the new deviation signal, and outputs the calculated average value.

The detailed description is further made with reference to the drawings.

As illustrated in FIG. 8, angular position detection device 702 for the resolver differs from angular position detection device 102 of the first exemplary embodiment in that RD converter 105 is replaced with average resolver digital converter 300. More exactly, angular position detection device 702 differs from angular position detection device 102 of the first exemplary embodiment in that average value calculator 714 is added in RD converter 105 in angular position detection device 102.

Average RD converter 300 will be described below with reference to FIGS. 9 and 10.

RD converter 1815 in FIG. 9 is a comparative example that is widely used as the angular position detection device for resolver 101. RD converter 1815 is called a tracking loop.

The first AD converter inputs A-phase signal (sine) to RD converter 1815. The A-phase signal input to RD converter 1815 is input to first multiplier 1801. First multiplier 1801 multiplies the A-phase signal by cosine wave signal (cos φ) output from cosine wave table 1805. First multiplier 1801 outputs the A-phase signal multiplied by the cosine wave signal to difference section 1803.

The second AD converter inputs B-phase signal (cos θ) to RD converter 1815. The B-phase signal input to RD converter 1815 is input to second multiplier 1802. Second multiplier 1802 multiplies the B-phase signal by sinusoidal wave signal (sin φ) output from sinusoidal wave table 1806. Second multiplier 1802 outputs the B-phase signal multiplied by the sinusoidal wave signal to difference section 1803.

Difference section 1803 calculates the difference between the output values of first multiplier 1801 and second multiplier 1802, and outputs error signal (sin(θ−φ)) as a calculation result. The calculated error signal is input to proportional-integral controller 1804. Hereinafter, the proportional-integral controller is also referred to as a “PI controller” in some cases.

PI controller 1804 performs integral processing, gain multiplication processing, and the like. As a result of the integral processing, the gain multiplication processing, and the like, PI controller 1804 outputs angle position φ of resolver 101.

Angle position φ of resolver 101, which is output from PI controller 1804, is input to cosine wave table 1805 and sinusoidal wave table 1806. The value of cosine wave signal (cos φ) is input to cosine wave table 1805 as the value of angle position φ of resolver 101. The value of sinusoidal wave signal (sin φ) is input to sinusoidal wave table 1806 as the value of angle position φ of resolver 101.

Through tracking loop processing, RD converter 1815 performs conversion processing by using the input A-phase and B-phase signals in order to calculate the angle position in resolver 101.

As illustrated in FIG. 10, average RD converter 300 of the second exemplary embodiment includes average value calculator 714 in addition to RD converter 705 forming tracking loop 707.

In average RD converter 300 in FIG. 10, error signal (sin(θ−φ)) output from difference section 1803 is input to average value calculator 714. Average value calculator 714 performs the averaging processing on the input error signal. The averaged error signal is output from average value calculator 714 to PI controller 1804.

Average value calculator 714 will be described below with reference to FIG. 11. Average value calculator 714 has the function similar to that of average value calculator 114 described in the case 1.

Average value calculator 714 stores the input signal in deviation signal storage 711. In the second exemplary embodiment, the deviation signal, that is the input signal, is stored in deviation signal storage 711 only for one-time sampling.

After the one-time sampling, the deviation signal, that is the new signal, is input to average value calculator 714. At this time, deviation signal storage 711 outputs the deviation signal stored in the last one-time sampling to deviation signal averaging section 712 as the past deviation signal. The deviation signal, that is the newly-input signal, is stored in deviation signal storage 711 as the new deviation signal.

Deviation signal averaging section 712 calculates the average value of the new deviation signal input from difference section 1803 and the past deviation signal input from deviation signal storage 711. Deviation signal averaging section 712 outputs the calculated average value.

In angle position detection device 702, the effect similar to A-phase average value calculator 503 and B-phase average value calculator 504 in the case 2 is obtained by action of average value calculator 714.

The reason and effect of the addition of average value calculator 714 in angle position detection device 702 for the resolver will be described below with reference to FIG. 5, where average resolver digital converter 300 is included in angle position detection device 702.

The following description has contents based on the case 1.

A-phase signal 5a1 and B-phase signal 5a2, output from resolver 101, have the slight phase shift relative to each other. At this point, as described in the mode 1, in the case where angle position detection device 102 of the first exemplary embodiment that does not include average value calculator 114 is used, the output value of RD converter 105 fluctuates in each sampling in which the sampling instruction signal is output. As illustrated in FIG. 5, output value 5c1 of the RD converter is indicated by a dotted line.

This phenomenon is disadvantageous in the application where the fast response performance and the high accuracy are required to detect the angle position in resolver 101.

Therefore, angle position detection device 702 including average value calculator 714 is used as illustrated in FIG. 8. At this point, the fluctuation is canceled in the output value of average RD converter 300. As illustrated in FIG. 5, output value 5c2 of average RD converter is indicated by a solid line that is a flat waveform by cancelling the fluctuation being canceled to obtain a flat waveform in output value 5c2.

Average value calculator 714 averages the values of the angle position in resolver 101 detected before and after the one-time sampling. The value averaged by average value calculator 714 is output as the angle position in resolver 101. The use of the averaged output value can accurately detect the angle position in resolver 101 with good response performance.

In the above explanation, deviation signal storage 711 stores therein the deviation signal only for the one-time sampling, and updates the signal to the new deviation signal at anytime, to store the new deviation signal.

The deviation signal stored in deviation signal storage 711 is not limited to the deviation signal for one-time sampling, but the deviation signal for a predetermined plurality of times of the sampling may be stored.

When the deviation signal for one-time sampling is stored in deviation signal storage 711, the calculation speed by deviation signal averaging section 712 increases and thus the response performance is improved. On the other hand, when the deviation signal for the plurality of times of the sampling is stored in deviation signal storage 711, the accuracy of the average value calculated by deviation signal averaging section 712 is improved.

In angle position detection device 702 for resolver 101 in FIG. 8, the degradation of the response performance slightly occurs compared with angle position detection device 102 for resolver 101 in FIG. 1. However, angle position detection device 702 for resolver 101 in FIG. 8 has the response performance faster than conventional angle position detection device 1102 for resolver 101 in FIG. 24 by about 1.5 times.

As for the amplitudes of the A-phase and B-phase signals, in the phase substantially located in the middle between the phase where the absolute value is the maximum and the phase where the absolute value is the minimum, the amplitudes of the A-phase and B-phase signals which are output from resolver 101 are about 0.7 time relative to the maximum value. However, as described above, the SN ratio is improved in angle position detection device 702 of the second exemplary embodiment by averaging the output values of the detected angle position in resolver 101 is detected. Therefore, the effect of the present invention can comprehensively ensure the sufficient superiority.

### Third Exemplary Embodiment

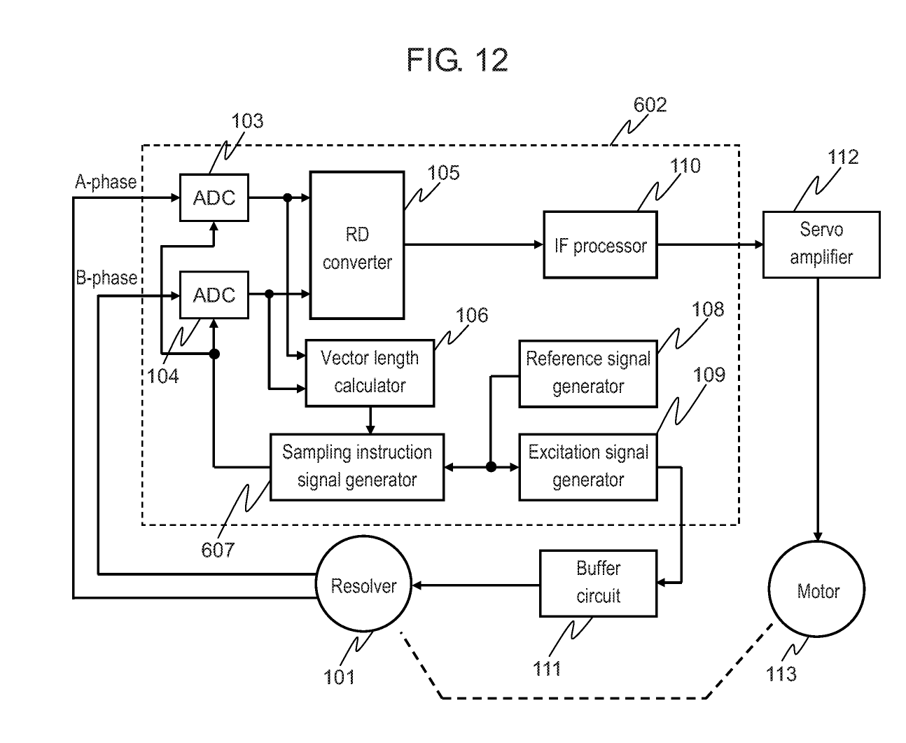

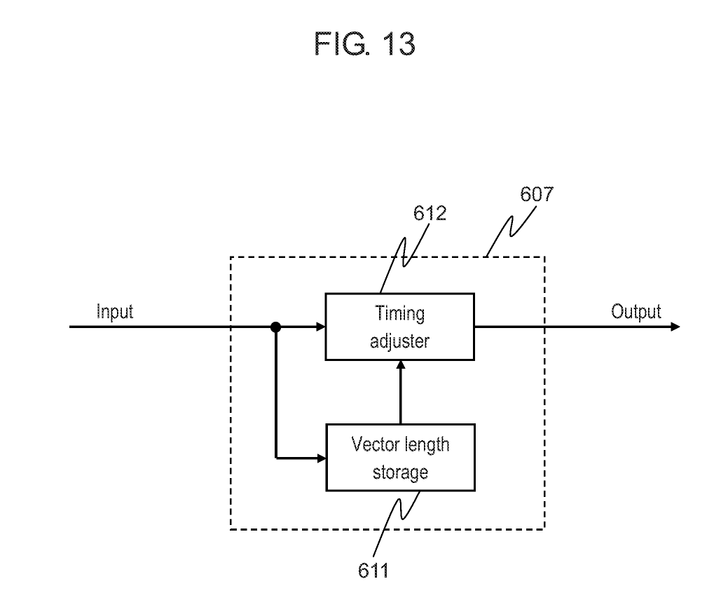

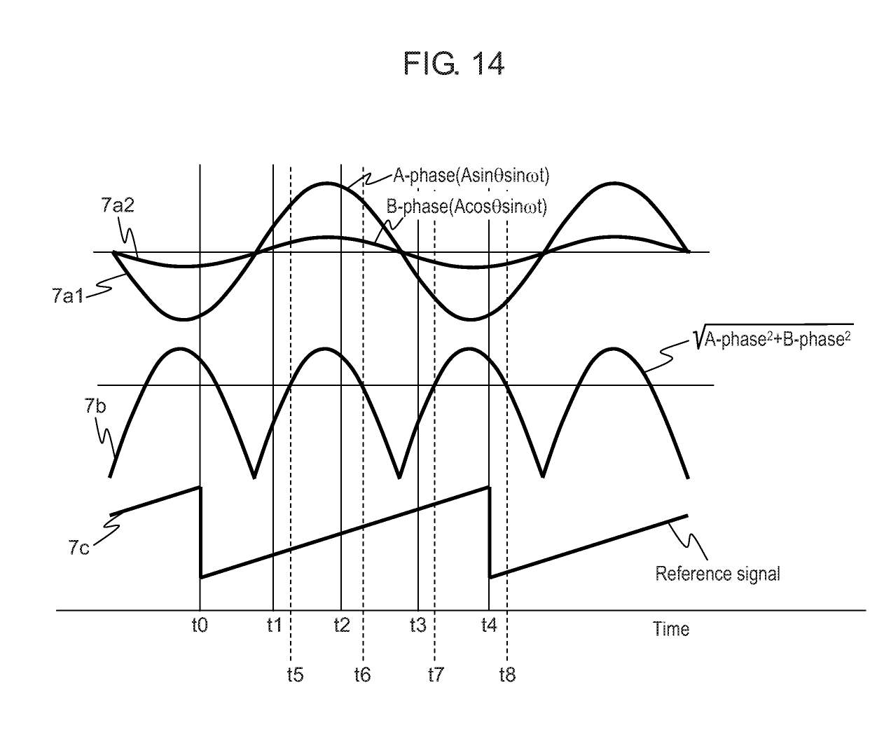

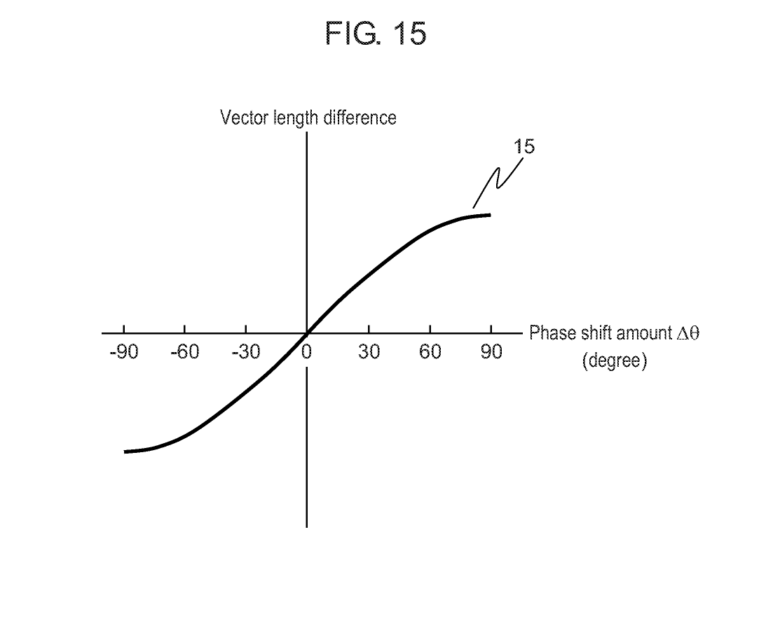

FIG. 12 is a block diagram illustrating a resolver angle detection device according to a third exemplary embodiment of the present invention. FIG. 13 is a block diagram illustrating a sampling instruction signal generator of the third exemplary embodiment of the present invention. FIG. 14 is a waveform chart illustrating signals in the third exemplary embodiment of the present invention. FIG. 15 is a waveform chart illustrating a change in vector length difference in the third exemplary embodiment of the present invention.

In the angle position detection device of the third exemplary embodiment, a vector length calculator is added to the angle position detection device of the first exemplary embodiment.

The angle position detection device of the third exemplary embodiment will be described below with reference to FIGS. 12 to 15.

The component having the same configuration as the first exemplary embodiment is designated by the same reference mark, and the description is cited.

As illustrated in FIG. 12, angle position detection device 602 of the third exemplary embodiment of the present invention further includes vector length calculator 106 in angle position detection device 102 of the first exemplary embodiment.

Input to vector length calculator 106 receives the first AD converted value output from first analog-digital converter 103 and second AD converted value output from second analog-digital converter 104, in response to the sampling instruction output from sampling instruction signal generator 607 in the third phase or the fourth phase. Vector length calculator 106 calculates a vector length indicating magnitude of a vector based on the received first and second AD converted values, and outputs the calculated vector length.

As illustrated in FIG. 13, particularly, sampling instruction signal generator 607 includes vector length storage 611 and timing adjuster 612.

As illustrated in FIGS. 12 and 13, vector length storage 611 stores the vector length, which is output from vector length calculator 106 in response to the sampling instruction output from sampling instruction signal generator 607 in the third phase or the fourth phase, as a first vector length.

Vector length storage 611 stores the vector length, which is newly output from vector length calculator 106 in response to the sampling instruction output from sampling instruction signal generator 607 in the fourth phase generated immediately after the third phase or the third phase generated immediately after the fourth phase, as a new first vector length instead of the stored first vector length.

Timing adjuster 612 receives the vector length, which is output from vector length calculator 106 in response to the sampling instruction output from sampling instruction signal generator 607 in the fourth phase generated immediately after the third phase or the third phase generated immediately after the fourth phase, as a second vector length.

Timing adjuster 612 adjusts the timing to output the sampling instruction signal such that the first vector length stored in vector length storage 611 is input to set a difference between the first and second vector lengths to zero before the third phase or the fourth phase.

The above configuration can adjust the timing to output the sampling instruction signal. Therefore, angle position detection device 602 of the third exemplary embodiment can easily perform the high-accuracy angle position detection.

The detailed description is further made with reference to the drawings.

As illustrated in FIG. 12, angle position detection device 602 for resolver 101 differs from angle position detection device 102 of the first exemplary embodiment in that vector length calculator 106 is added. Additionally, sampling instruction signal generator 607 has a unique function.

The outputs of the first AD converter 103 and second AD converter 104 are input to vector length calculator 106. Vector length calculator 106 calculates the vector length based on the outputs of first AD converter 103 and second AD converter 104. Vector length calculator 106 outputs the calculated vector length.

Sampling instruction signal generator 607 outputs the sampling instruction signal to first AD converter 103 and second AD converter 104 based on the signal input from reference signal generator 108. Sampling instruction signal generator 607 has a function of adjusting the phase of the sampling instruction signal based on the vector length output from vector length calculator 106.

Sampling instruction signal generator 607 will be described below with reference to FIG. 13.

Sampling instruction signal generator 607 stores the input signal in vector length storage 611. In the third exemplary embodiment, the first vector length of the input signal only for one-time sampling is stored in vector length storage 611.

After the one-time sampling, the second vector length being the new signal is input to timing adjuster 612. At this point, vector length storage 611 outputs the first vector length stored in the last one-time sampling to timing adjuster 612. The newly-input signal is stored as the new first vector length in vector length storage 611.

Timing adjuster 612 adjusts the timing to output the sampling instruction signal such that the a difference between the second vector length input from vector length calculator 106 and the first vector length input from vector length storage 611 is set to zero.

The operation and action of the angle position detection device for resolver 101 having the above configuration in a control device of motor 113 will be described below.

FIG. 14 illustrates A-phase signal 7a1 and B-phase signal 7a2, which are output from resolver 101. As described above, A-phase signal 7a1 and B-phase signal 7a2 are signals that are the excitation signal (sin ωt) amplitude-modulated in resolver 101. A-phase signal 7a1 and B-phase signal 7a2 are amplitude-modulated while having the phase difference of 90 degrees relative to each other.

Assuming that θ is the angle position in resolver 101, A-phase signal 7a1 is expressed by A sin θ sin ωt, and B-phase signal 7a2 is expressed by A cos θ sin ωt. Here A is the amplitude of the signal.

A-phase signal 7a1 and B-phase signal 7a2 are amplitude-modulated while having the phase difference of 90 degrees relative to each other. Therefore, considering the two signals as the vectors, the vector length indicating the length of the vector is expressed the following equation.

\sqrt{(A sin θ sin ωt)²+(A cos θ sin ωt)²}=\sqrt{(A sin ωt)²} [Mathematical Formula 1]

That is, the vector length becomes |A sin ωt|.

When angle position θ of resolver 101 changes, the amplitudes of A-phase signal 7a1 and B-phase signal 7a2 differ from the amplitude in FIG. 14. However, the vector length is independent of angle position θ of resolver 101, and is always kept constant. Additionally, the vector length is synchronized with the reference signal, A-phase signal 7a1, and B-phase signal 7a2.

Accordingly, even if resolver 101 rotates, angle position detection device 602 can easily and correctly detect the vector length. Because the vector length can easily and correctly be detected, angle position detection device 602 can decide the optimum timing to output the sampling instruction signal from sampling instruction signal generator 607.

A process of adjusting the timing to output the sampling instruction signal using the vector length will be described below with a specific example.

FIG. 14 illustrates vector length value 7b and reference signal 7c. Vector length value 7b is output from vector length calculator 106. Reference signal 7c is output from reference signal generator 108.

As illustrated in FIG. 14, sampling instruction signal generator 607 outputs the sampling instruction signal four times at equal intervals in one period of reference signal 7c. This corresponds to the phase difference of 90 degrees. In an initial state, sampling instruction signal generator 607 outputs the sampling instruction signal at times t1, t2, t3, and t4. In this case, the vector length value at time t1 differs largely from the vector length value at time t2. Similarly, the vector length value at time t3 differs largely from the vector length value at clock time t4. Times t1, t2, t3, and t4 deviate from the time corresponding to the phase located in the middle between the phases in which the magnitudes of the A-phase and B-phase signals are the maximum and the minimum.

After being generated by excitation signal generator 109 based on reference signal 7c, excitation signal (sin ωt) is input to resolver 101 through buffer circuit 111.

Accordingly, a phase relationship among reference signal 7c, A-phase signal 7a1, and B-phase signal 7a2 is described as follows. (1) The excitation signal is generated from reference signal 7c. (2) The generated excitation signal is transmitted to first AD converter 103 and second AD converter 104 through resolver 101. (3) A-phase signal 7a1 and B-phase signal 7a2 are converted into the digital values based on the transmitted excitation signal. Reference signal 7c, A-phase signal 7a1, and B-phase signal 7a2 are influenced by a phase delay and a delay, which are generated in the transmission processes (1) to (3).

Possibly, a property of each component disposed in the transmission passage is also influenced by a temperature change and aging. Therefore, it is necessary to adjust the timing of the sampling instruction signal.

As illustrated in FIG. 14, sampling instruction signal generator 607 adjusts the timing of the sampling instruction signal to be output such that the magnitudes of the vector lengths are equal at the timing to output the sampling instruction signal. Specifically, sampling instruction signal generator 607 calculates a difference between the value stored in the last one-time sampling and the latest value with respect to the magnitude of the vector length output from vector length calculator 106. Sampling instruction signal generator 607 adjusts the timing of the sampling instruction signal such that the difference becomes zero.

When the timing to output the sampling instruction signal is adjusted through the processing, the sampling instruction signal is output at times t5, t6, t7, and t8 in FIG. 14. In this case, the vector length values at times t5 and t6 are substantially equal to each other. The vector length values at times t7 and t8 are substantially equal to each other.

A time interval at which the sampling instruction signal is output corresponds to the phase difference of 90 degrees. Therefore, times t5, t6, t7, and t8 naturally become the time corresponding to the phase located in the middle between the phases in which the magnitudes of the A-phase and B-phase signals are the maximum and the minimum.

The sampling instruction signal has phase shift amount Δθ from the phase substantially located in the middle. On the other hand, as illustrated in FIG. 15, a difference between the magnitude of the vector length value and the magnitude of the vector length value stored in the last one-time sampling becomes curve 15 of a sinusoidal wave function passing through an origin of zero. Therefore, a negative feedback loop is formed in a region where phase shift amount Δθ is relatively small, thereby the timing to output the sampling instruction signal can be adjusted such that phase shift amount Δθ automatically becomes zero.

Additionally, by forming the negative feedback loop, the timing to continuously output the sampling instruction signal can automatically be adjusted while the operation to detect the angle position is performed, after the initial adjustment. Therefore, each component disposed in the transmission line can deal with the phase shift caused by the factor such as the temperature change.

Thus, sampling instruction signal generator 607 adjusts the timing to output the sampling instruction signal using vector length calculator 106. Vector length calculator 106 calculates the vector magnitude using the output values of first AD converter 103 and second AD converter 104 being output according to the timing to output the sampling instruction signal. Sampling instruction signal generator 607 stores the output value of vector length calculator 106, which is output in the last one-time sampling. Sampling instruction signal generator 607 compares the output values, which are outputs from vector length calculator 106 before and after the one-time sampling, to each other, and adjusts the timing to output the sampling instruction signal such that the difference between the output values becomes zero. Consequently, sampling instruction signal generator 607 can output the sampling instruction signal in the phase located substantially in the middle between the phases in which the magnitudes of A-phase and B-phase signals are maximized and minimized. Therefore, for example, in angle position detection device 602 of the third exemplary embodiment, the angle position in resolver 101 can stably be detected with high accuracy by the configuration in FIG. 12.

In the one-cycle period excitation signal, the above processing can be performed while the vector length is acquired four times. Therefore, in angle position detection device 602 of the third exemplary embodiment, the timing to output the sampling instruction signal can be adjusted in a shorter time than ever before.

In the above description, the vector length is calculated using the calculation of the square root. However, the square root is not necessarily calculated in the calculation of the vector length. For example, the calculation of the square root may be omitted in the calculation of the vector length due to a processing time and the like.

### Fourth Exemplary Embodiment

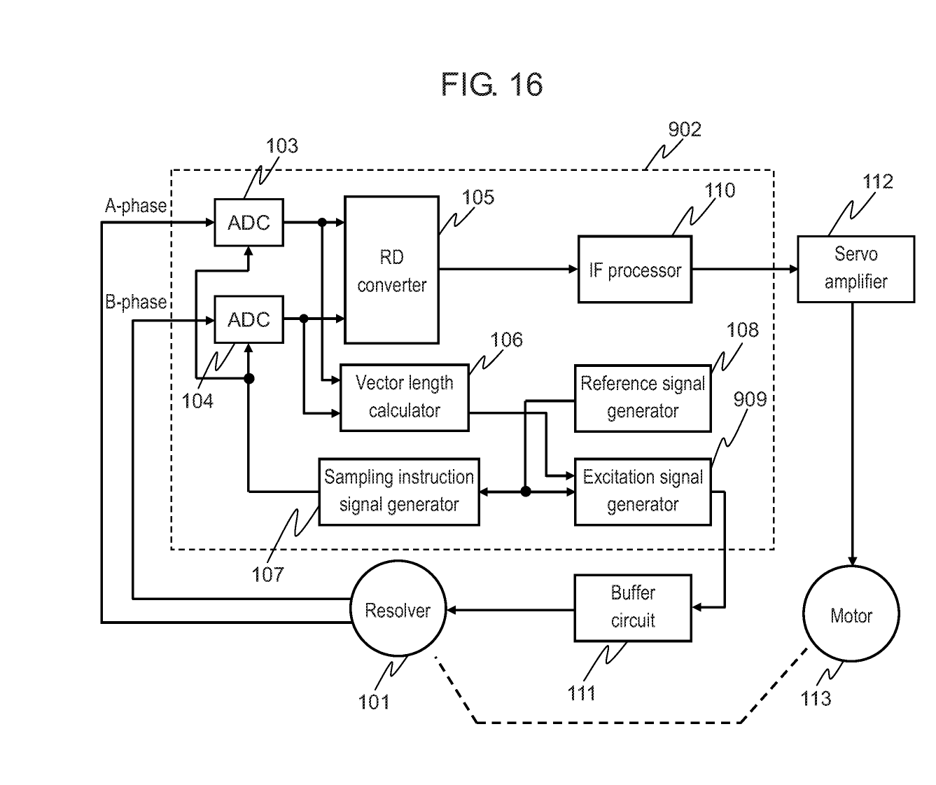

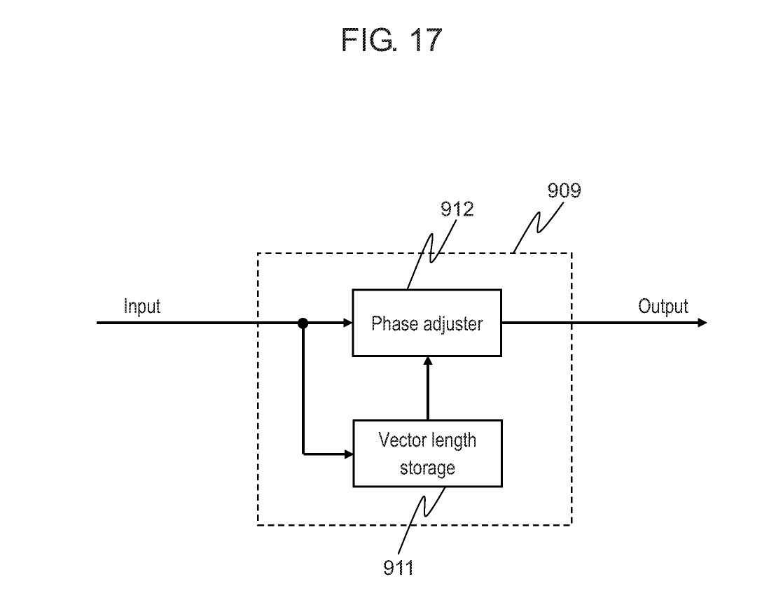

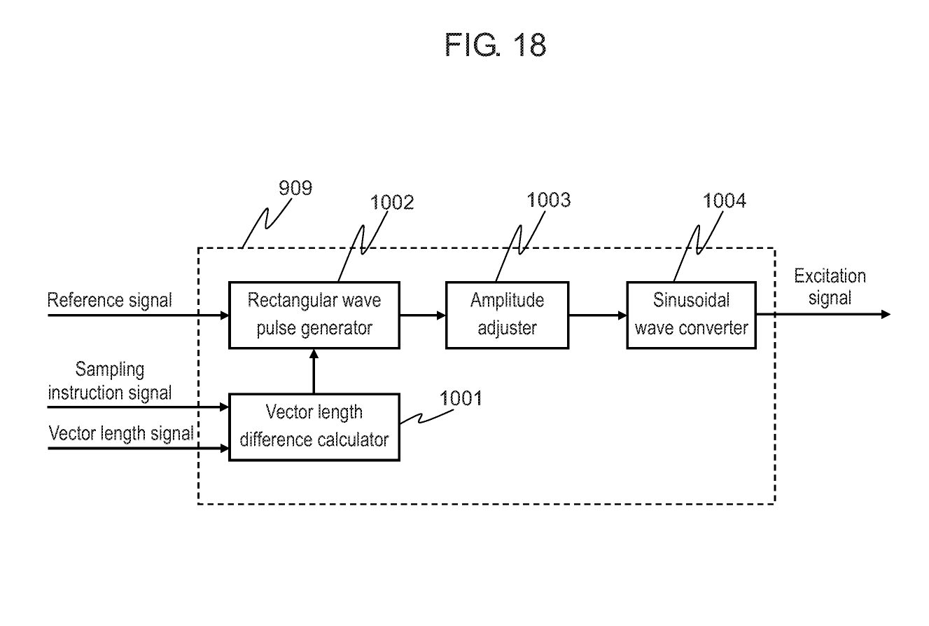

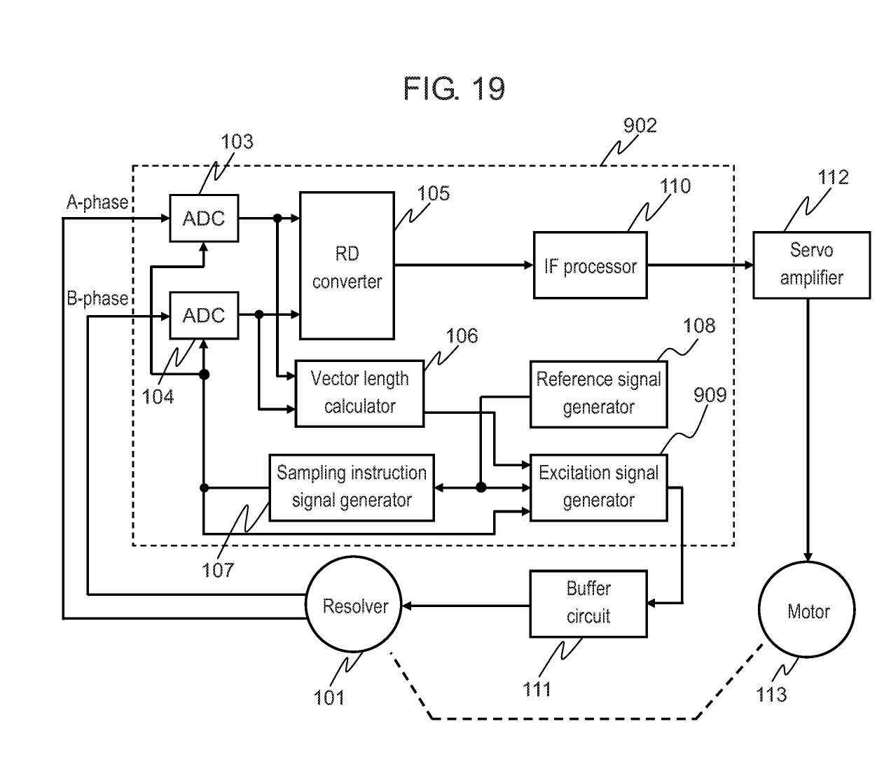

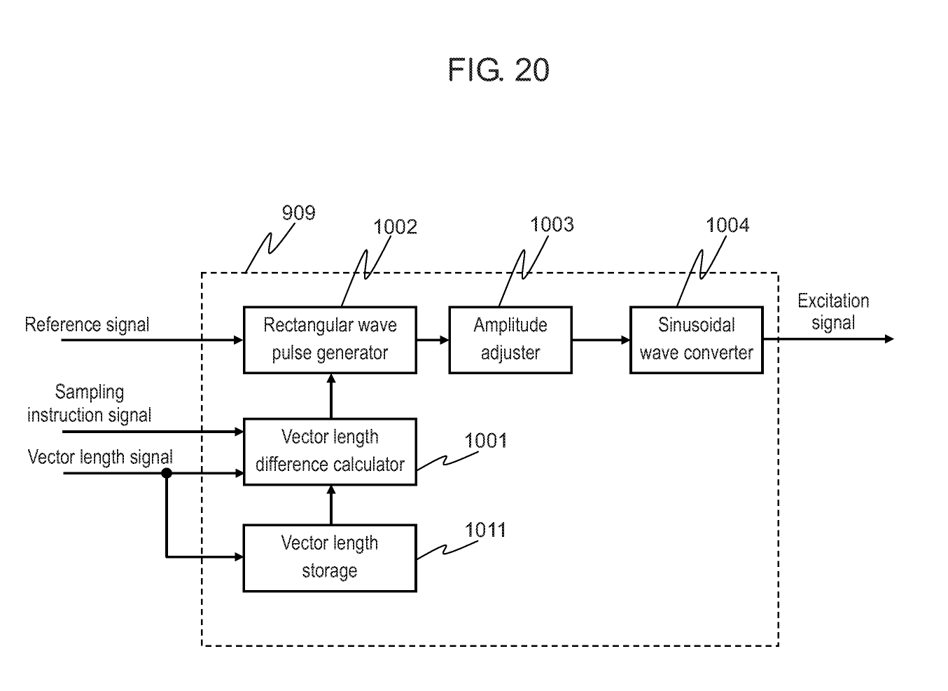

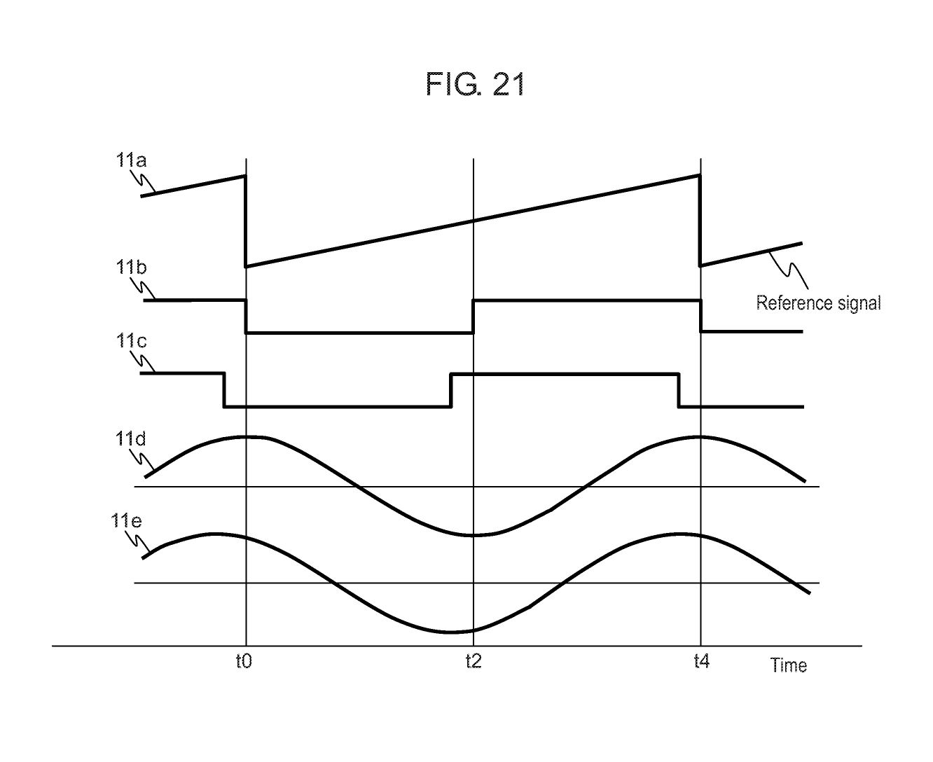

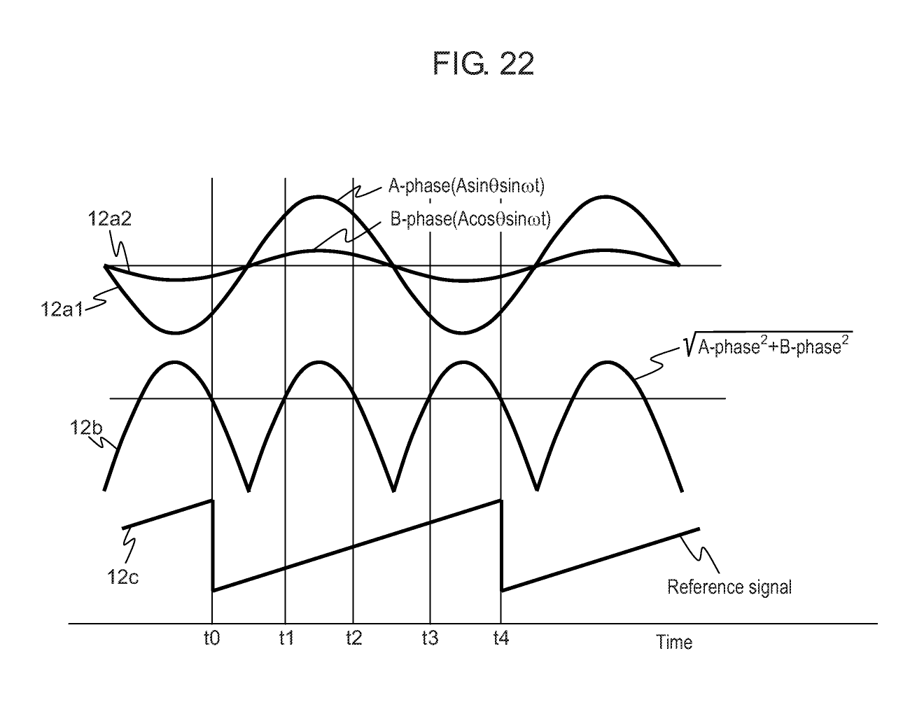

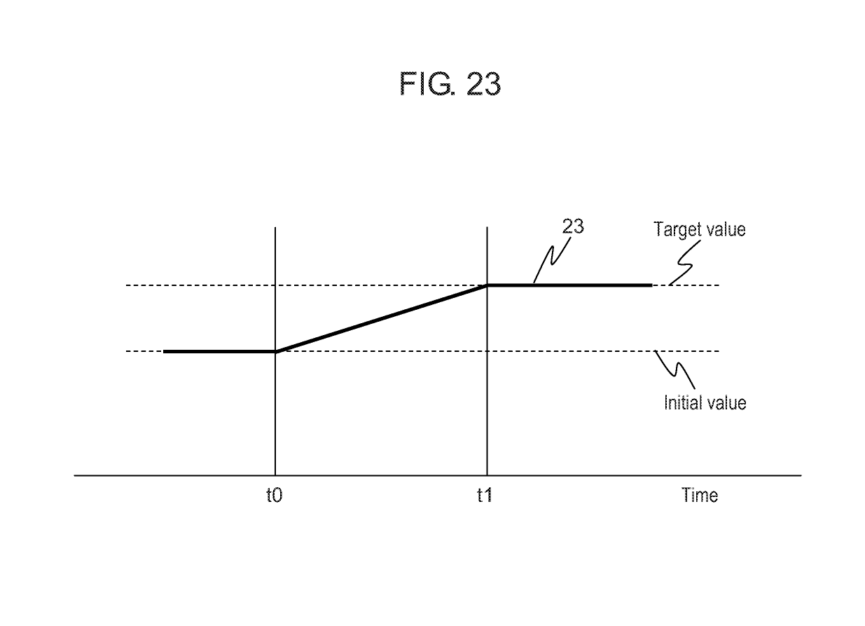

FIG. 16 is a block diagram illustrating a resolver angle detection device according to a fourth exemplary embodiment of the present invention. FIG. 17 is a block diagram illustrating an excitation signal generator of the fourth exemplary embodiment of the present invention. FIG. 18 is a block diagram illustrating another excitation signal generator of the fourth exemplary embodiment of the present invention. FIG. 19 is a block diagram illustrating another resolver angle detection device of the fourth exemplary embodiment of the present invention. FIG. 20 is a block diagram illustrating still another excitation signal generator of the fourth exemplary embodiment of the present invention. FIG. 21 is a waveform chart illustrating signals in the fourth exemplary embodiment of the present invention. FIG. 22 is a waveform chart illustrating other signals in the fourth exemplary embodiment of the present invention. FIG. 23 is a waveform chart illustrating a change in vector length value 23 in the fourth exemplary embodiment of the present invention.

The angle position detection device of the fourth exemplary embodiment further includes the vector length calculator and an excitation signal generator in the angle position detection device of the first exemplary embodiment.

The angle position detection device of the fourth exemplary embodiment will be described below with reference to FIGS. 16 to 23.

The component having the same configuration as the first exemplary embodiment is designated by the same reference mark, and the description is cited.

As illustrated in FIG. 16, angle position detection device 902 of the fourth exemplary embodiment of the present invention further includes vector length calculator 106 and excitation signal generator 909 in angle position detection device 102 of the first exemplary embodiment.

Vector length calculator 106 receives the first AD converted value which is output from first analog-digital converter 103 and the second AD converted value which is output from second analog-digital converter 104 in response to the sampling instruction output from sampling instruction signal generator 107 in the third phase or the fourth phase. Vector length calculator 106 calculates a vector length indicating magnitude of a vector based on the received first and second AD converted values, and outputs the calculated vector length.

As illustrated in FIG. 17, excitation signal generator 909 includes vector length storage 911 and phase adjuster 912.

As illustrated in FIGS. 16 and 17, vector length storage 911 stores, as a first vector length, the vector length, which is output from vector length calculator 106 in response to the sampling instruction output from sampling instruction signal generator 107 in the third phase or the fourth phase.

Vector length storage 911 stores the vector length, which is newly output from vector length calculator 106 in response to the sampling instruction output from sampling instruction signal generator 107 in the fourth phase generated immediately after the third phase or the third phase generated immediately after the fourth phase, as new first vector length, instead of the stored first vector length.

Phase adjuster 912 receives the vector length, which is output from vector length calculator 106 in response to the sampling instruction output from sampling instruction signal generator 107 in the fourth phase generated immediately after the third phase or the third phase generated immediately after the fourth phase, as a second vector length.

Phase adjuster 912 adjusts the phase of the excitation signal exciting resolver 101 such that the first vector length stored in vector length storage 911 is input to set a difference between the first and second vector lengths to zero before the third phase or the fourth phase.

The configuration can relatively adjust the timing to output the sampling instruction signal. Therefore, the angle position detection device of the fourth exemplary embodiment can easily perform the high-accuracy angle position detection.

As illustrated in FIG. 18, angle position detection device 902 of the fourth exemplary embodiment may have the following configuration.

Excitation signal generator 909 further includes rectangular wave pulse generator 1002 and amplitude adjuster 1003.

Rectangular pulse generator 1002 outputs a first rectangular wave pulse based on an adjustment result of phase adjuster 912.

Amplitude adjuster 1003 receives the first rectangular wave pulse, and outputs a second rectangular wave pulse for adjusting the amplitude of the excitation signal exciting resolver 101 according to the received first rectangular wave pulse.

In the configuration, the amplitude of the signal output from the resolver, namely, the amplitude of the signal input from the first AD converter and the amplitude of the signal input from the second AD converter are adjusted to proper values. Therefore, the angle position detection device of the fourth exemplary embodiment can easily perform the high-accuracy angle position detection.

Angle position detection device 902 of the fourth exemplary embodiment of the present invention may further include sinusoidal wave converter 1004.

Sinusoidal wave converter 1004 receives the second rectangular wave pulse, converts the received second rectangular wave pulse to a sinusoidal wave having the same frequency as that of the second rectangular wave pulse, and outputs the converted sinusoidal wave.

In the configuration, the phase of the excitation signal can easily be adjusted.

In particular, sinusoidal wave converter 1004 may be a low-pass filter. In the configuration, sinusoidal wave conversion processing can easily be performed.

As illustrated in FIG. 19, another angle position detection device 902 of the fourth exemplary embodiment of the present invention further includes reference signal generator 108, vector length calculator 106, and excitation signal generator 909 in angle position detection device 102 of the first exemplary embodiment.

Reference signal generator 108 generates the reference signal provided to resolver 101, and outputs the generated reference signal.

Vector length calculator 106 receives the first AD converted value which is output from first analog-digital converter 103 and second AD converted value which is output from second analog-digital converter 104 in response to the sampling instruction output from sampling instruction signal generator 107 in the third phase or the fourth phase. Vector length calculator 106 calculates a vector length indicating magnitude of a vector based on the received first and second AD converted values, and outputs the calculated vector length.

As illustrated in FIG. 20, excitation signal generator 909 includes vector length storage 1011, vector length difference calculator 1001, and rectangular wave pulse generator 1002.

As illustrated in FIGS. 19 and 20, vector length storage 1011 stores the vector length, which is output from vector length calculator 106 in response to the sampling instruction output from sampling instruction signal generator 107 in the third phase or the fourth phase, as a first vector length.

Vector length storage 1011 stores the vector length, which is newly output from vector length calculator 106 in response to the sampling instruction output from sampling instruction signal generator 107 in the fourth phase generated immediately after the third phase or the third phase generated immediately after the fourth phase, as new first vector length, instead of the stored first vector length.

Vector length difference calculator 1001 receives the sampling instruction, which is output from sampling instruction signal generator 107 in the fourth phase generated immediately after the third phase or the third phase generated immediately after the fourth phase, as a first sampling instruction.

Vector length difference calculator 1001 receives the vector length output from vector length calculator 106 in response to the first sampling instruction, as a second vector length.

Vector length difference calculator 1001 receives the first vector length stored in vector length storage 1011, calculates a vector length difference signal that is of a difference between the first and second vector lengths, and outputs the calculated vector length difference signal.

Rectangular wave pulse generator 1002 receives the vector length difference signal output from vector length difference calculator 1001 and the reference signal output from reference signal generator 108.

Rectangular wave pulse generator 1002 generates a rectangular wave pulse according to the vector length difference signal and the reference signal such that the difference between the first and second vector lengths becomes zero, and rectangular wave pulse generator 1002 outputs the generated rectangular wave pulse.

Angle position detection device 902 of the fourth exemplary embodiment of the present invention may further include amplitude adjuster 1003.

Amplitude adjuster 1003 receives the first rectangular wave pulse, and outputs a second rectangular wave pulse for adjusting the amplitude of the excitation signal exciting the resolver according to the received first rectangular wave pulse.

Angle position detection device 902 of the fourth exemplary embodiment of the present invention may further include sinusoidal wave converter 1004.

Sinusoidal wave converter 1004 receives the second rectangular wave pulse, converts the received second rectangular wave pulse in a sinusoidal wave having the same frequency as that of the second rectangular wave pulse, and outputs the converted sinusoidal wave.

In particular, sinusoidal wave converter 1004 may be a low-pass filter.

The detailed description is further made with reference to the drawings.

As illustrated in FIG. 19, angle position detection device 902 for resolver 101 differs from the angle position detection device of the first exemplary embodiment in that excitation signal generator 909 has a characteristic function.

Excitation signal generator 909 receives the vector length value output from vector length calculator 106 and the reference signal output from reference signal generator 108. Excitation signal generator 909 generates the excitation signal based on the received signal. Excitation signal generator 909 outputs the generated excitation signal.

As illustrated in FIG. 20, the signal of the vector length output from vector length calculator 106 and the sampling instruction signal output from sampling instruction signal generator 107 are input to vector length difference calculator 1001. Vector length difference calculator 1001 calculates a difference between the vector length value and the vector length value stored in the last one-time sampling. Vector length difference calculator 1001 outputs a calculation result.

Rectangular wave pulse generator 1002 outputs the rectangular wave pulse based on the reference signal. Rectangular wave pulse generator 1002 has a function of adjusting the phase of the rectangular wave pulse output from rectangular wave pulse generator 1002 while reflecting the value of vector length difference output from vector length difference calculator 1001.

Amplitude adjuster 1003 adjusts the amplitude of the rectangular wave pulse output from rectangular wave pulse generator 1002, and outputs an adjustment result.

Sinusoidal wave converter 1004 converts the rectangular wave pulse output from amplitude adjuster 1003 into the sinusoidal wave having the same frequency, and outputs a conversion result. The conversion result becomes the excitation signal output from excitation signal generator 909.

A switched capacitor filter having a steep low-pass cutoff characteristic can be used as sinusoidal wave converter 1004. When the switched capacitor filter is used as sinusoidal wave converter 1004, sinusoidal wave converter 1004 can easily be configured.

The operation and action of angle position detection device 902 for resolver 101 having the above configuration in the control device of the motor will be described below.

FIG. 14 illustrates A-phase signal 7a1 and B-phase signal 7a2, which are output from resolver 101. FIG. 14 also illustrates vector length value 7b output from vector length calculator 106 and reference signal 7c output from reference signal generator 108. These signals of angle position detection device 902 for resolver 101 of the fourth exemplary embodiment of the present invention are similarly to those of the third exemplary embodiment of the present invention.

As illustrated in FIG. 14, sampling instruction signal generator 107 outputs the sampling instruction signal four times at equal intervals in one period of reference signal 7c. This corresponds to the phase difference of 90 degrees. In the initial state, sampling instruction signal generator 107 outputs the sampling instruction signal at times t1, t2, t3, and t4. In this case, the vector length value at time t1 differs largely from the vector length value at time t2. Similarly, the vector length value at time t3 differs largely from the vector length value at time t4. Times t1, t2, t3, and t4 deviate from the time corresponding to the phase located in the middle between the phases in which the magnitudes of the A-phase and B-phase signals are the maximum and the minimum.

After being generated by excitation signal generator 909 based on reference signal 7c, excitation signal (sin ωt) is input to resolver 101 through buffer circuit 111.

Accordingly, a phase relationship among reference signal 7c, A-phase signal 7a1, and B-phase signal 7a2 is described as follows. (1) The excitation signal is generated from reference signal 7c. (2) The generated excitation signal is transmitted to first AD converter 103 and second AD converter 104 through resolver 101. (3) A-phase signal 7a1 and B-phase signal 7a2 are influenced by a phase delay and a delay, which is generated in the transmission processes (1) to (3), based on the transmitted excitation signal.

Possibly, a property of each component disposed in the transmission passage is also influenced by a temperature change and aging. Therefore, similarly to the third exemplary embodiment, it is necessary to adjust the timing of the sampling instruction signal.

The detailed timing adjustment process will be described with reference to FIGS. 21 to 23.

FIG. 21 illustrates reference signal 11a. FIG. 21 also illustrates rectangular wave pulse signal 11b output from rectangular wave pulse generator 1002 in the initial state. Similarly, FIG. 21 illustrates the signal output from sinusoidal wave converter 1004 in the initial state, namely, excitation signal 11d output from excitation signal generator 909 in the initial state.

As described above, in the initial state, the vector length varies largely at times t1, t2, t3, and t4 in FIG. 14. That is, the value of the vector length difference output from vector length difference calculator 1001 deviates from zero.

Therefore, the phase of the rectangular wave pulse output from rectangular wave pulse generator 1002 is changed such that the value of the vector length difference becomes zero.

That is, as illustrated in FIG. 21, signal 11c output from rectangular wave pulse generator 1002 is the signal of which the phase shifts forward. Therefore, the signal output from sinusoidal wave converter 1004, namely, excitation signal 11e output from excitation signal generator 909 is the signal of which the phase shifts forward based on signal 11c output from rectangular wave pulse generator.

FIG. 22 illustrates the result. FIG. 22 illustrates A-phase signal 12a1 and B-phase signal 12a2, which are output from resolver 101, vector length value 12b output from vector length calculator 106, and reference signal 12c output from reference signal generator 108.

The waveforms in FIG. 22 are compared to the waveforms in FIG. 14. Then the following results are obtained.

A-phase signals 7a1 and 12a1 and B-phase signals 7a2 and 12a2, which are output from resolver 101, and vector length values 7b and 12b output from vector length calculator 106 are the signals of which the phases shift forward with respect to reference signals 7c and 12c output from reference signal generator 108.

As illustrated in FIG. 22, when angle position detection device 902 of the fourth exemplary embodiment is used, the vector length value at time t1 is substantially equal to the vector length value at time t2 through the processing of adjusting the phase of the excitation signal. Similarly, the vector length value at time t3 is substantially equal to the vector length value at time t4.

The time interval at which the sampling instruction signal is output corresponds to the phase difference of 90 degrees. Therefore, times t1, t2, t3, and t4 naturally become the time corresponding to the phase located in the middle between the phases in which the magnitudes of the A-phase and B-phase signals are the maximum and the minimum.

The sampling instruction signal has phase shift amount Δθ from the phase substantially located in the middle. On the other hand, as illustrated in FIG. 15, a difference between the magnitude of the vector length value and the magnitude of the vector length value stored in the last one-time sampling becomes curve 15 of a sinusoidal wave function passing through an origin of zero. Therefore, a negative feedback loop is formed in a region where phase shift amount Δθ is relatively small, whereby the timing to output the sampling instruction signal can be adjusted such that phase shift amount Δθ automatically becomes zero.

Additionally, when the negative feedback loop is formed, the timing to continuously output the sampling instruction signal can automatically be adjusted while the operation to detect the angle position is performed after the initial adjustment. Therefore, each component disposed in the transmission passage can deal with the phase shift caused by the factor such as the temperature change.

Thus, as illustrated in FIG. 19, excitation signal generator 909 adjusts the phase of the excitation signal exciting the resolver through the following process. Vector length calculator 106 calculates the vector magnitude using the output values of first AD converter 103 and second AD converter 104 being output according to the timing to output the sampling instruction signal. Excitation signal generator 909 stores the output value of vector length calculator 106, which is output in the last one-time sampling. Excitation signal generator 909 compares the output values, which are output from vector length calculator 106 before and after the one-time sampling, to each other, and adjusts the phase of the excitation signal exciting the resolver such that the difference between the output values becomes zero. The timing to output the sampling instruction signal is matched to the phase substantially located in the middle between the phases in which the magnitudes of A-phase and B-phase signals are maximized and minimized. Therefore, for example, in angle position detection device 902 of the fourth exemplary embodiment, the angle position in resolver 101 can stably be detected with high accuracy by the configuration in FIG. 19.

As illustrated in FIG. 20, because excitation signal generator 909 includes amplitude adjuster 1003, excitation signal generator 909 can adjust the amplitude of the excitation signal. As described above, the amplitude of the excitation signal can be adjusted using the vector length value. The initial adjustment of the amplitude of the excitation signal can be performed by forming the negative feedback loop using a difference between the vector length value and a target value. Additionally, after the initial adjustment, the amplitude of the excitation signal can continuously be adjusted while the operation to detect the angle position of the resolver is performed. Therefore, angle position detection device 902 of the fourth exemplary embodiment can deal with the amplitude deviation caused by the factor such as the temperature change.

As illustrated in FIG. 23, angle position detection device 902 of the fourth exemplary embodiment starts the adjustment of the amplitude of the excitation signal at time t0. Then, vector length value 23 increases gradually from the initial value at time t0, and reaches the target value at time t1. Thus, angle position detection device 902 completes the initial adjustment of the amplitude of the excitation signal. As described above, in order to accurately and stably perform the initial adjustment of the amplitude of the excitation signal, desirably the initial adjustment of the amplitude of the excitation signal is performed after the phase of the excitation signal is adjusted. The amplitude of the signal of resolver 101 is adjusted to a proper value by adjusting the amplitude of the excitation signal, where the signal is input to first AD converter 103 and second AD converter 104. Therefore, by using angle position detection device 902 of the fourth exemplary embodiment, the angle position in resolver 101 is more stably and accurately detected.

In the processing performed by angle position detection device 902 of the fourth exemplary embodiment, the vector length can be acquired four times in the one-period excitation signal. Therefore, in angle position detection device 902 of the fourth exemplary embodiment, the phase and amplitude of the excitation signal can be adjusted in a shorter time than ever before.

In the above description, the vector length is calculated using the calculation of the square root. However, the square root is not necessarily calculated in the calculation of the vector length. For example, the calculation of the square root may be omitted in the calculation of the vector length due to a processing time and the like.

### INDUSTRIAL APPLICABILITY

As described above, in the resolver angle position detection device of the present invention, the angle position can accurately be detected with good response performance. In the angle position detection device of the present invention, the timing of the sampling instruction signal output to the AD converter and the phase of the excitation signal can be adjusted while including the variation in property, temperature change, or aging of the resolver. Therefore, the angle position detection device of the present invention can stably and accurately detect the angle position of the resolver. Accordingly, the angle position detection device of the present invention can be applied to an industrial FA servo motor and the like.

### REFERENCE MARKS IN THE DRAWINGS

2a1, 5a1, 7a1, 12a1, 15a1 A-phase signal
2a2, 5a2, 5a3, 7a2, 12a2, 15a2 B-phase signal
2b, 5b, 7c, 11a, 12c, 15b reference signal
5c1 RD output value of converter
5c2 output value of average RD converter
7b, 12b vector length value
11b rectangular wave pulse signal
11c signal output from rectangular wave pulse generator
11e excitation signal
15 curve
23 vector length value
101 resolver
102, 302, 502, 602, 702, 902, 1102 angle position detection device
103 first analog-digital converter (first AD converter)
104 second analog-digital converter (second AD converter)
105, 705, 1815 resolver digital converter (RD converter)
106 vector length calculator
107, 607, 1107 sampling instruction signal generator
108 reference signal generator
109 excitation signal generator
110 interface processor (IF processor)
111 buffer circuit
112 servo amplifier
113 motor
114, 514, 714 average value calculator
300 average resolver digital converter (average RD converter)
401 angle data storage
402 angle data averaging section
503 A-phase average value calculator
504 B-phase average value calculator
511 first AD converted value storage
512 first AD converted value averaging section
521 second AD converted value storage
522 second AD converted value averaging section
611, 911, 1011 vector length storage
612 timing adjuster
711 deviation signal storage
712 deviation signal averaging section
707 tracking loop
909 excitation signal generator
912 phase adjuster
1001 vector length difference calculator
1002 rectangular wave pulse generator
1003 amplitude adjuster
1004 sinusoidal wave converter
1801 first multiplier
1802 second multiplier
1803 difference section
1804 proportional-integral controller (PI controller)
1805 cosine wave table
1806 sinusoidal wave table

1-26. (canceled)

27. An angle position detection device comprising:
a resolver configured to output an A-phase signal having an amplitude modulated, and a B-phase signal having a phase difference of 90 degrees relative to the A-phase signal and having an amplitudes modulated;
a sampling instruction signal generator configured to output a sampling instruction signal in a third phase and a fourth phase, in case that, in at least one of the A-phase signal and the B-phase signal, it is defined that a magnitude of the A-phase signal or B-phase signal is at a minimum thereof at a first phase, the magnitude of the A-phase signal or B-phase signal is at a maximum thereof at a second phase, a third phase is located in a middle of a change from the first phase to the second phase, and the fourth phase being is in a middle of a change from the second phase to the first phase;
a first analog-digital converter configured to receive the A-phase signal when the sampling instruction signal is input, to convert a magnitude of the A-phase signal received into a digital value to generate a first AD converted value, and to output the first AD converted value generated;
a second analog-digital converter configured to receive the B-phase signal when the sampling instruction signal is input, to convert a magnitude of the B-phase signal received into a digital value to generate a second AD converted value, and to output the generated second AD converted value;
a resolver digital converter configured to receive the first AD converted value and the second AD converted value, to calculate angle data indicating an angle position in the resolver based on the first AD converted value received and the second AD converted value received, and to output the angle data calculated; and
a vector length calculator configured to receive the first AD converted value output from the first analog-digital converter and the second AD converted value output from the second analog-digital converter, in response to the sampling instruction output from the sampling instruction signal generator in the third phase or the fourth phase, to calculate a vector length indicating a magnitude of a vector based on the received first and second AD converted values, and to output the vector length calculated,
wherein the sampling instruction signal generator includes:
a vector length storage configured to store the vector length output from the vector length calculator in response to the sampling instruction output from the sampling instruction signal generator in the third phase or the fourth phase, as a first vector length, to store, the vector length newly output from the vector length calculator in response to the sampling instruction output from the sampling instruction signal generator in the third phase or the fourth phase as a new first vector length instead of the stored first vector length; and
a timing adjuster configured to receive the vector length output from the vector length calculator in response to the sampling instruction output from the sampling instruction signal generator in the third phase or the fourth phase as a second vector length, and to receive the first vector length stored in the vector length storage, and the timing adjuster configured to adjust timing to output the sampling instruction signal such that a difference between the first vector length and the second vector length becomes zero.

28. An angle position detection device comprising:
a resolver configured to output an A-phase signal having an amplitude modulated, and a B-phase signal having a phase difference of 90 degrees relative to the A-phase signal and having an amplitudes modulated;
a sampling instruction signal generator configured to output a sampling instruction signal in a third phase and a fourth phase, in case that, in at least one of the A-phase signal and the B-phase signal, it is defined that a magnitude of the A-phase signal or B-phase signal is at a minimum thereof at a first phase, the magnitude of the A-phase signal or B-phase signal is at a maximum thereof at a second phase, a third phase is located in a middle of a change from the first phase to the second phase, and the fourth phase being is in a middle of a change from the second phase to the first phase;
a first analog-digital converter configured to receive the A-phase signal when the sampling instruction signal is input, to convert a magnitude of the A-phase signal received into a digital value to generate a first AD converted value, and to output the first AD converted value generated;
a second analog-digital converter configured to receive the B-phase signal when the sampling instruction signal is input, to convert a magnitude of the B-phase signal received into a digital value to generate a second AD converted value, and to output the generated second AD converted value;
a resolver digital converter configured to receive the first AD converted value and the second AD converted value, to calculate angle data indicating an angle position in the resolver based on the first AD converted value received and the second AD converted value received, and to output the angle data calculated; and
a vector length calculator configured to receive the first AD converted value output from the first analog-digital converter and the second AD converted value output from the second analog-digital converter, in response to the sampling instruction output from the sampling instruction signal generator in the third phase or the fourth phase, the vector length calculator configured to calculate a vector length indicating a magnitude of a vector based on the received first and second AD converted values, and configured to output the vector length calculated,
wherein the sampling instruction signal generator includes:
a vector length storage configured to store the vector length output from the vector length calculator in response to the sampling instruction output from the sampling instruction signal generator in the third phase or the fourth phase, as a first vector length, and configured to store the vector length newly output from the vector length calculator in response to the sampling instruction output from the sampling instruction signal generator in the fourth phase generated immediately after the third phase or the third phase generated immediately after the fourth phase, as a new first vector length instead of the stored first vector length; and
a timing adjuster configured to receive the vector length output from the vector length calculator in response to the sampling instruction output from the sampling instruction signal generator in the fourth phase generated immediately after the third phase or the third phase generated immediately after the fourth phase, as a second vector length, and configured to receive the first vector length stored in the vector length storage before the third phase or the fourth phase, the timing adjuster configured to adjust timing to output the sampling instruction signal such that a difference between the first vector length and the second vector length becomes zero.

29. An angle position detection device comprising:
a resolver configured to output an A-phase signal having an amplitude modulated, and a B-phase signal having a phase difference of 90 degrees relative to the A-phase signal and having an amplitudes modulated;
a sampling instruction signal generator configured to output a sampling instruction signal in a third phase and a fourth phase, in case that, in at least one of the A-phase signal and the B-phase signal, it is defined that a magnitude of the A-phase signal or B-phase signal is at a minimum thereof at a first phase, the magnitude of the A-phase signal or B-phase signal is at a maximum thereof at a second phase, a third phase is located in a middle of a change from the first phase to the second phase, and the fourth phase being is in a middle of a change from the second phase to the first phase;
a first analog-digital converter configured to receive the A-phase signal when the sampling instruction signal is input, to convert a magnitude of the A-phase signal received into a digital value to generate a first AD converted value, and to output the first AD converted value generated;
a second analog-digital converter configured to receive the B-phase signal when the sampling instruction signal is input, to convert a magnitude of the B-phase signal received into a digital value to generate a second AD converted value, and to output the generated second AD converted value;
a resolver digital converter configured to receive the first AD converted value and the second AD converted value, to calculate angle data indicating an angle position in the resolver based on the first AD converted value received and the second AD converted value received, and to output the angle data calculated; and
a vector length calculator configured to receive the first AD converted value output from the first analog-digital converter and the second AD converted value output from the second analog-digital converter, in response to the sampling instruction output from the sampling instruction signal generator in the third phase or the fourth phase, the vector length calculator configured to calculate a vector length indicating a magnitude of a vector based on the first AD converted value received and the second AD converted value received, and configured to output the calculated vector length,
wherein the sampling instruction signal generator includes:
a vector length storage configured to store the vector length output from the vector length calculator in response to the sampling instruction output from the sampling instruction signal generator in the third phase or the fourth phase, as a first length, and configured to store the vector length newly output from the vector length calculator in response to the sampling instruction output from the sampling instruction signal generator in the fourth phase generated immediately after the third phase or the third phase generated immediately after the fourth phase, as a new first vector length instead of the stored first vector length; and
a timing adjuster configured to receive the vector length output from the vector length calculator in response to the sampling instruction output from the sampling instruction signal generator in the fourth phase generated immediately after the third phase or the third phase generated immediately after the fourth phase, as a second vector length, and configured to receive the first vector length stored in the vector length storage, the timing adjuster configured to adjust timing to output the sampling instruction signal such that a difference between the first vector length and the second vector length becomes zero.

30. An angle position detection device comprising:
a resolver configured to output an A-phase signal having an amplitude modulated, and a B-phase signal having a phase difference of 90 degrees relative to the A-phase signal and having an amplitudes modulated;
a sampling instruction signal generator configured to output a sampling instruction signal in a third phase and a fourth phase, in case that, in at least one of the A-phase signal and the B-phase signal, it is defined that a magnitude of the A-phase signal or B-phase signal is at a minimum thereof at a first phase, the magnitude of the A-phase signal or B-phase signal is at a maximum thereof at a second phase, a third phase is located in a middle of a change from the first phase to the second phase, and the fourth phase being is in a middle of a change from the second phase to the first phase;
a first analog-digital converter configured to receive the A-phase signal when the sampling instruction signal is input, to convert a magnitude of the A-phase signal received into a digital value to generate a first AD converted value, and to output the first AD converted value generated;
a second analog-digital converter configured to receive the B-phase signal when the sampling instruction signal is input, to convert a magnitude of the B-phase signal received into a digital value to generate a second AD converted value, and to output the generated second AD converted value;
a resolver digital converter configured to receive the first AD converted value and the second AD converted value, to calculate angle data indicating an angle position in the resolver based on the first AD converted value received and the second AD converted value received, and to output the angle data calculated; and
an excitation signal generator including:
a vector length calculator configured to receive the first AD converted value output from the first analog-digital converter and the second AD converted value output from the second analog-digital converter, in response to the sampling instruction output from the sampling instruction signal generator in the third phase or the fourth phase, the vector length calculator configured to calculate a vector length indicating a magnitude of a vector based on the first and the second AD converted value received, and configured to output the vector length calculated;
a vector length storage configured to store the vector length output from the vector length calculator in response to the sampling instruction output from the sampling instruction signal generator in the third phase or the fourth phase, as a first vector length, and configured to store the vector length newly output from the vector length calculator in response to the sampling instruction output from the sampling instruction signal generator in the third phase or the fourth phase, as a new first vector length instead of the stored first vector length; and
a phase adjuster configured to receive the vector length output from the vector length calculator in response to the sampling instruction output from the sampling instruction signal generator in the third phase or the fourth phase and configured to receive the first vector length stored in the vector length storage, as a second vector length, the phase adjuster configured to adjust the phase of the excitation signal exciting the resolver such that a difference between the first vector length and the second vector length becomes zero.

31. An angle position detection device comprising:
a resolver configured to output an A-phase signal having an amplitude modulated, and a B-phase signal having a phase difference of 90 degrees relative to the A-phase signal and having an amplitudes modulated;
a sampling instruction signal generator configured to output a sampling instruction signal in a third phase and a fourth phase, in case that, in at least one of the A-phase signal and the B-phase signal, it is defined that a magnitude of the A-phase signal or B-phase signal is at a minimum thereof at a first phase, the magnitude of the A-phase signal or B-phase signal is at a maximum thereof at a second phase, a third phase is located in a middle of a change from the first phase to the second phase, and the fourth phase being is in a middle of a change from the second phase to the first phase;
a first analog-digital converter configured to receive the A-phase signal when the sampling instruction signal is input, to convert a magnitude of the A-phase signal received into a digital value to generate a first AD converted value, and to output the first AD converted value generated;
a second analog-digital converter configured to receive the B-phase signal when the sampling instruction signal is input, to convert a magnitude of the B-phase signal received into a digital value to generate a second AD converted value, and to output the generated second AD converted value;
a resolver digital converter configured to receive the first AD converted value and the second AD converted value, to calculate angle data indicating an angle position in the resolver based on the first AD converted value received and the second AD converted value received, and to output the angle data calculated; and
an excitation signal generator including:
a vector length calculator configured to receive the first AD converted value output from the first analog-digital converter and the second AD converted value output from the second analog-digital converter, in response to the sampling instruction output from the sampling instruction signal generator in the third phase or the fourth phase, the vector length calculator configured to calculate a vector length indicating a magnitude of a vector based on the first AD converted value received and the second AD converted value received and to output the vector length calculated;
a vector length storage configured to store the vector length output from the vector length calculator in response to the sampling instruction output from the sampling instruction signal generator in the third phase or the fourth phase, as a first vector length, and configured to store the vector length newly output from the vector length calculator in response to the sampling instruction output from the sampling instruction signal generator in the fourth phase generated immediately after the third phase or the third phase generated immediately after the fourth phase, as a new first vector length instead of the stored first vector length; and
a phase adjuster configured to receive the vector length output from the vector length calculator in response to the sampling instruction output from the sampling instruction signal generator in the fourth phase generated immediately after the third phase or the third phase generated immediately after the fourth phase, as a second vector length, and configured to receive the first vector length stored in the vector length storage before the third phase or the fourth phase, the phase adjuster configured to adjust the phase of the excitation signal exciting the resolver such that a difference between the first vector length and the second vector length becomes zero.

32. The angle position detection device according to claim 31, wherein the excitation signal generator includes:
a rectangular wave pulse generator configured to output a first rectangular wave pulse based on an adjustment result of the phase adjuster; and
an amplitude adjuster configured to receive the first rectangular wave pulse, and to output a second rectangular wave pulse for adjusting an amplitude of the excitation signal exciting the resolver in accordance with the first rectangular wave pulse received.

33. The angle position detection device according to claim 32, further comprising a sinusoidal wave converter configured to receive the second rectangular wave pulse, to convert the received second rectangular wave pulse into a sinusoidal wave having a frequency identical to a frequency of the second rectangular wave pulse, and to output the converted sinusoidal wave.

34. The angle position detection device according to claim 33, wherein the sinusoidal wave converter is a low-pass filter.

35. An angle position detection device comprising:
a resolver configured to output an A-phase signal having an amplitude modulated, and a B-phase signal having a phase difference of 90 degrees relative to the A-phase signal and having an amplitudes modulated;
a sampling instruction signal generator configured to output a sampling instruction signal in a third phase and a fourth phase, in case that, in at least one of the A-phase signal and the B-phase signal, it is defined that a magnitude of the A-phase signal or B-phase signal is at a minimum thereof at a first phase, the magnitude of the A-phase signal or B-phase signal is at a maximum thereof at a second phase, a third phase is located in a middle of a change from the first phase to the second phase, and the fourth phase being is in a middle of a change from the second phase to the first phase;
a first analog-digital converter configured to receive the A-phase signal when the sampling instruction signal is input, to convert a magnitude of the A-phase signal received into a digital value to generate a first AD converted value, and to output the first AD converted value generated;
a second analog-digital converter configured to receive the B-phase signal when the sampling instruction signal is input, to convert a magnitude of the B-phase signal received into a digital value to generate a second AD converted value, and to output the generated second AD converted value;
a resolver digital converter configured to receive the first AD converted value and the second AD converted value, to calculate angle data indicating an angle position in the resolver based on the first AD converted value received and the second AD converted value received, and to output the angle data calculated; and
an excitation signal generator including:
a reference signal generator configured to generate a reference signal to be provided to the resolver, and to output the generated reference signal;
a vector length calculator configured to receive the first AD converted value output from the first analog-digital converter and the second AD converted value output from the second analog-digital converter in response to the sampling instruction output from the sampling instruction signal generator in the third phase or the fourth phase, the vector length calculator configured to calculate a vector length indicating a magnitude of a vector based on the first second AD converted received and the second AD converted value received, and to output the calculated vector length;
a vector length storage configured to store the vector length output from the vector length calculator in response to the sampling instruction output from the sampling instruction signal generator in the third phase or the fourth phase, as a first vector length, and configured to store the vector length newly output from the vector length calculator in response to the sampling instruction output from the sampling instruction signal generator in the fourth phase generated immediately after the third phase or the third phase generated immediately after the fourth phase, as a new first vector length instead of the stored first vector length;
a vector length difference calculator configured to receive the sampling instruction output from the sampling instruction signal generator in the fourth phase generated immediately after the third phase or the third phase generated immediately after the fourth phase, as a first sampling instruction, to receive, as a second vector length, the vector length output from the vector length calculator in response to the first sampling instruction, as a second vector length, and to receive the first vector length stored in the vector length storage, and the vector length difference calculator configured to calculate a vector length difference signal that is of a difference generated between the first vector length and the second vector length, and the vector length difference calculator configured to output the vector length difference signal calculated; and
a rectangular wave pulse generator configured to receive the vector length difference signal output from the vector length difference calculator and the reference signal output from the reference signal generator, the rectangular wave pulse generator configured to generate a rectangular wave pulse in accordance with the vector length difference signal and the reference signal such that a difference between the first vector length and the second vector length becomes zero, and the rectangular wave pulse generator configured to output the rectangular wave pulse generated.

36. The angle position detection device according to claim 35, further comprising an amplitude adjuster configured to receive the first rectangular wave pulse, and to output a second rectangular wave pulse for adjusting the amplitude of the excitation signal for exciting the resolver in accordance with the first rectangular wave pulse received.

37. The angle position detection device according to claim 36, further comprising a sinusoidal wave converter configured to receive the second rectangular wave pulse, to convert the second rectangular wave pulse received into a sinusoidal wave having a frequency identical to a frequency of the second rectangular wave pulse, and to output the sinusoidal wave converted.

38. The angle position detection device according to claim 37, wherein the sinusoidal wave converter is a low-pass filter.

39. An angle position detection device comprising:
a resolver configured to output an A-phase signal having an amplitude modulated, and a B-phase signal having a phase difference of 90 degrees relative to the A-phase signal and having an amplitudes modulated;
a sampling instruction signal generator configured to output a sampling instruction signal in a third phase and a fourth phase, in case that, in at least one of the A-phase signal and the B-phase signal, it is defined that a magnitude of the A-phase signal or B-phase signal is at a minimum thereof at a first phase, the magnitude of the A-phase signal or B-phase signal is at a maximum thereof at a second phase, a third phase is located in a middle of a change from the first phase to the second phase, and the fourth phase being is in a middle of a change from the second phase to the first phase;
a first analog-digital converter configured to receive the A-phase signal when the sampling instruction signal is input, to convert a magnitude of the A-phase signal received into a digital value to generate a first AD converted value, and to output the first AD converted value generated;
a second analog-digital converter configured to receive the B-phase signal when the sampling instruction signal is input, to convert a magnitude of the B-phase signal received into a digital value to generate a second AD converted value, and to output the generated second AD converted value;
a resolver digital converter configured to receive the first AD converted value and the second AD converted value, to calculate angle data indicating an angle position in the resolver based on the first AD converted value received and the second AD converted value received, and to output the angle data calculated;
a vector length calculator configured to receive the first AD converted value output from the first analog-digital converter and the second AD converted value output from the second analog-digital converter, the vector length calculator configured to calculate a vector length indicating a magnitude of a vector based on the first AD converted value received and the second AD converted value received, and to output the vector length calculated;
an excitation signal generator configured to output an excitation signal exciting the resolver; and
a timing adjuster configured to adjust timing to output the sampling instruction signal with respect to the phase of the excitation signal such that a difference between the first vector length and the second vector length becomes zero, when it is defined that the vector length in timing of the sampling instruction signal in the third phase is a first vector length, and the vector length in timing of the sampling instruction signal in the fourth phase is a second vector length.

40. An angle position detection device comprising:
a resolver configured to output an A-phase signal having an amplitude modulated, and a B-phase signal having a phase difference of 90 degrees relative to the A-phase signal and having an amplitudes modulated;
a sampling instruction signal generator configured to output a sampling instruction signal in a third phase and a fourth phase, in case that, in at least one of the A-phase signal and the B-phase signal, it is defined that a magnitude of the A-phase signal or B-phase signal is at a minimum thereof at a first phase, the magnitude of the A-phase signal or B-phase signal is at a maximum thereof at a second phase, a third phase is located in a middle of a change from the first phase to the second phase, and the fourth phase being is in a middle of a change from the second phase to the first phase;
a first analog-digital converter configured to receive the A-phase signal when the sampling instruction signal is input, to convert a magnitude of the A-phase signal received into a digital value to generate a first AD converted value, and to output the first AD converted value generated;
a second analog-digital converter configured to receive the B-phase signal when the sampling instruction signal is input, to convert a magnitude of the B-phase signal received into a digital value to generate a second AD converted value, and to output the generated second AD converted value;
a resolver digital converter configured to receive the first AD converted value and the second AD converted value, to calculate angle data indicating an angle position in the resolver based on the first AD converted value received and the second AD converted value received, and to output the angle data calculated;
a vector length calculator configured to receive the first AD converted value output from the first analog-digital converter and the second AD converted value output from the second analog-digital converter, the vector length calculator configured to calculate a vector length indicating a magnitude of a vector based on the first AD converted value received and the second AD converted value received, and to output the vector length calculated; and
an excitation signal generator configured to output an excitation signal exciting the resolver and that includes a phase adjuster for adjusting the phase of the excitation signal such that a difference between the first vector length and the second vector length becomes zero, when it is defined that the vector length in timing of the sampling instruction signal in the third phase is a first vector length, and the vector length in timing of the sampling instruction signal in the fourth phase is a second vector length.

41. The angle position detection device according to claim 40, wherein the excitation signal generator includes:
a rectangular wave pulse generator configured to output a first rectangular wave pulse based on an adjustment result of the phase adjuster; and
an amplitude adjuster configured to receive the first rectangular wave pulse, and to output a second rectangular wave pulse for adjusting an amplitude of the excitation signal exciting the resolver in accordance with the first rectangular wave pulse received.

42. The angle position detection device according to claim 41, further comprising a sinusoidal wave converter configured to receive the second rectangular wave pulse, to convert the received second rectangular wave pulse into a sinusoidal wave having a frequency identical to a frequency of the second rectangular wave pulse, and to output the sinusoidal wave converted.

43. The angle position detection device according to claim 42, wherein the sinusoidal wave converter is a low-pass filter.
